(19) United States
(12) Patent Application Publication
(10) Pub. No.: US 2013/0290494 A1
(43) Pub. Date: Oct. 31, 2013

(54) SESSION MANAGEMENT FOR COMMUNICATION IN A HETEROGENEOUS NETWORK

(71) Applicants: Rouzbeh Moazami Goudarzi, Los Gatos, CA (US); John K. Thomas, Saratoga, CA (US); Ioannis Georgiadis, Voula (GR); Mark J. Grimse, San Jose, CA (US); Carl W. Werner, Los Gatos, CA (US)

(72) Inventors: Rouzbeh Moazami Goudarzi, Los Gatos, CA (US); John K. Thomas, Saratoga, CA (US); Ioannis Georgiadis, Voula (GR); Mark J. Grimse, San Jose, CA (US); Carl W. Werner, Los Gatos, CA (US)

(73) Assignee: RAMBUS INC., Sunnyvale, CA (US)

(21) Appl. No.: 13/996,449

(22) PCT Filed: Oct. 20, 2011
(86) PCT No.: PCT/US11/57132

§ 371 Date: Jun. 20, 2013

Related U.S. Application Data
(60) Provisional application No. 61/426,059, filed on Dec. 22, 2010.

(51) Int. Cl. H04L 29/06

(52) U.S. Cl. CPC H04L 65/1083
USPC 709/219

(57) ABSTRACT

The present disclosure describes one embodiment of an operating center server for managing communication sessions between terminal devices such as mobile phones, VOIP phones, and computers for example. The OC server creates and maintains sessions for one or more terminal devices that allow communication between these disparate devices on disparate communication networks through the OC server.

### BACKGROUND

The present disclosure relates to session management of multiple data streams in a heterogeneous communication network.

In the present age, communication between people may be performed using a vast array of different types of communication platforms. People may communicate with one another via circuit switched phone calls, email, voice-over internet protocol (VOIP) calls, and short message service (SMS) messages, for example. Because of the different types of communication platforms available to people and the number of people who communicate using these platforms, the voice and data networks used to support the platforms are oversubscribed in many service areas. As a result of the oversubscription, the operators of the voice and data networks are under increasing pressure to efficiently use their licensed network and offload traffic whenever possible in order to provide their subscribers ubiquitous connectivity.

### BRIEF DESCRIPTION OF THE DRAWINGS

The teachings of the embodiments of the present disclosure can be readily understood by considering the following detailed description in conjunction with the accompanying drawings.

FIG. 1 illustrates a network system including an operating center server for session management of multiple data streams in a heterogeneous communication network, according to one embodiment.

FIG. 2 illustrates the various functional software modules of the operating center server for session management, according to one embodiment.

FIG. 3 illustrates the various attributes of a communication session, according to one embodiment.

FIG. 4 illustrates an example of an established communication session of communication, according to one embodiment.

FIG. 5 illustrates an example of a user profile, according to one embodiment.

FIG. 6 illustrates an example of a contact policy, according to one embodiment.

FIGS. 7A, 7B, and 7C illustrate a sideband channel of the network system, according to one embodiment.

FIG. 8A illustrates a method for facilitating communication, according to one embodiment.

FIG. 8B illustrates a method for device mobility, according to one embodiment.

FIG. 8C illustrates a method for network mobility, according to one embodiment.

FIG. 9 illustrates a method for establishing a communication path, according to one embodiment.

FIG. 10 illustrates the various functional software modules of the operating center server, according to one embodiment.

FIG. 11 illustrates the various functional software modules of the terminal device, according to one embodiment.

FIG. 12 illustrates the hardware architecture of the operating center server, according to one embodiment.

FIG. 13 illustrates the storage module of the operating center server storing various functional software modules for session management, according to one embodiment.

FIGS. 14A, 14B, 14C, 14D, 14E, and 14F illustrate various menus of a user interface of a client application, according to one embodiment.

### DETAILED DESCRIPTION OF EMBODIMENTS

The present disclosure describes an operating center (OC) server for managing communication sessions between terminal devices such as mobile phones, VOIP phones, and computers for example. The OC server converges cellular connectivity services (e.g., cellular calls or SMS messages) with internet protocol (IP)-based communication services (e.g., email or VOIP calls) and provides these services to terminal devices regardless of the specific network connectivity available to the devices. The OC server creates and maintains sessions for one or more terminal devices so as to enable communication between these disparate devices. For example, the OC server creates a communication session that allows disparate terminal devices such as a cellular phone and a VOIP phone to communicate with each other.

In one embodiment, a session comprises communication data used to facilitate the communication between terminal devices that may be operating on disparate communication networks. The communication data includes a plurality of terminal device attributes, such as: (i) identification of the terminal devices being used in communication and their respective functional capabilities (e.g., ability to render audio and video and receive/transmit data over a cellular network or WLAN), (ii) data type being used during communication (e.g., the attributes may describe an audio stream or a video stream (i.e., a video conference) being communicated between terminal devices through the OC server), and/or advertisement data, that may be overlaid onto the media stream, (iii) description of the roles of the terminal devices in the session, which determine the actions that may or may not be performed by terminal devices in a communication session (e.g., whether a terminal device may only receive data, or if it may also transmit data), (iv) online peripherals (i.e., other terminal devices) that are local to the terminal devices that are being used in the communication session, and so on.

In one embodiment, a user's terminal device includes a user agent or client application (e.g., a software application) that is used to communicate with the OC server. While the user agent or client application is connected to the OC server, the OC server maintains a session using the attributes of the terminal device. The terminal device may transmit a request to initiate communication with a second user where the request terminates at the OC server. The OC server determines the communication means by which to contact the second user according to a contact policy or attribute of the second user. Based on the contact policy, the OC server updates the communication session with the attributes of the terminal device(s) of the second user indicated by the contact policy. One or more types of data (e.g., media streams) are then communicated to the terminal device of the second user and are managed by the OC server. Thus, the OC server facilitates the communication between the terminal device of the first user and the terminal device of the second user.

In one embodiment, the OC server provides device mobility for terminal devices. That is, the OC server allows a first user (in communication with a second user or with an information source such as a server on the Internet or a uniform resource locator (URL)) to transfer an active communication session (or part of the session) from the first user's first terminal device to the first user's second terminal device without interrupting communication between the first user and the second user. That is, the first user may transfer the communication to another device that is accessible to the first user. Thus, at the request of the first user's first terminal device, media streams or portions of streams may be re-directed by the OC server from one terminal device to other terminal devices of the user that sent the request. For example, the user may initially use a cellular phone for communication with a second user, but decide to switch the audio communication with the second user from the cellular phone to his or her VOIP phone.

To provide device mobility, in one embodiment, the OC server receives from a terminal device in active communication, a request to access other terminal devices near the current location of the terminal device in active communication with the OC. The OC server confirms that the user of the terminal device has permission to access the one or more of the other terminal devices based on a profile for the user associated with the other terminal devices. After authenticating the other terminal device, communication of the media streams are moved to the other terminal device(s) indicated in the request and the previously active terminal device is removed from the communication session. The OC server then updates the communication session with the attributes of the newly moved terminal device.

In one embodiment, the OC server allows for network mobility. That is, the OC server allows users to move an active session from a first communication network technology to a second communication network if the user's terminal device is capable of operating on the second communication network. For example, while a video call is in progress on a 3G or 4G cellular network, the OC server may move the call on the same terminal device from the cellular network to an IP-based network such as WiFi for the audio and video streams of the video call.

In one embodiment, the terminal device may transmit a request to the OC server 145 to move an active communication session from one communication network to another communication network when the terminal device obtains access to the other communication network. The OC server analyzes the new communication network to determine whether it can support the media streams in the active communication session. Responsive to the OC server determining that the new communication network can support the session, the OC server registers and authenticates the terminal device with the new communication network. The OC server contacts the terminal device using the new communication network and upon acceptance of the communication, the OC server disconnects the terminal device from the previous communication network. The communication session is updated to reflect the migration to the new communication network.

Reference will now be made to several embodiments of the present disclosure, examples of which are illustrated in the accompanying figures. It is noted that wherever practicable similar or like reference numbers may be used in the figures and may indicate similar or like functionality. The figures depict embodiments of the present disclosure for purposes of illustration only. One skilled in the art will readily recognize from the following description that alternative embodiments of the structures and methods illustrated herein may be employed without departing from the principles of the disclosure described herein.

### System Overview

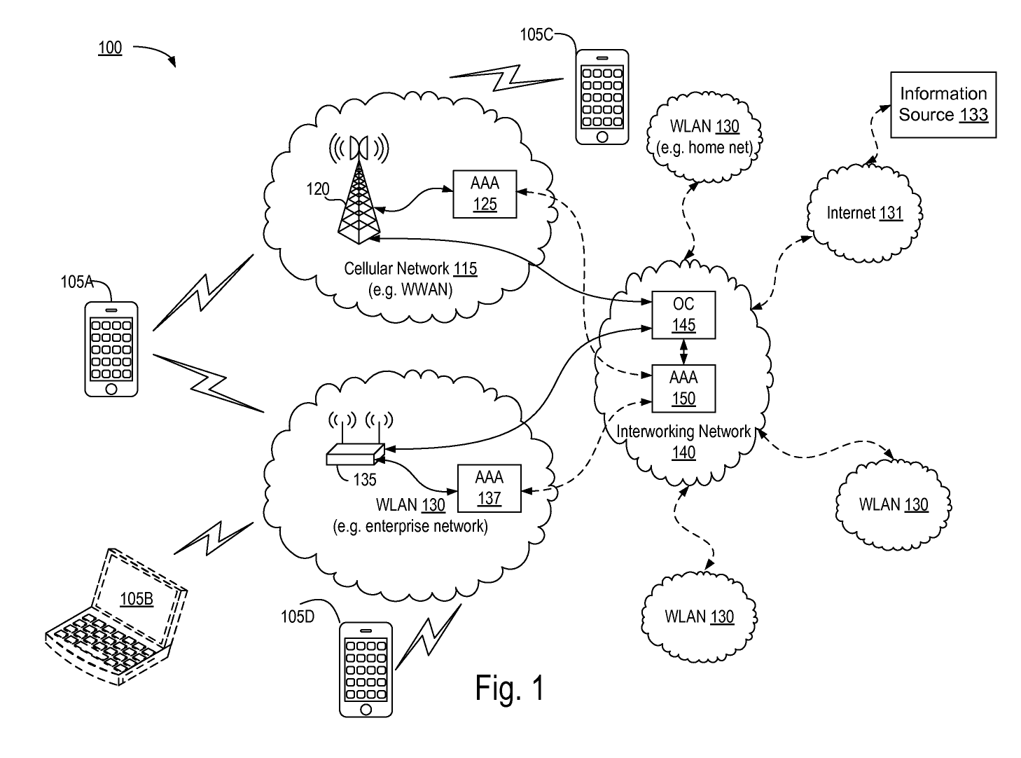

FIG. 1 depicts a network system 100 in accordance with one embodiment of the present disclosure. The network system 100 comprises an interworking network 140 in communication with terminal devices 105A, 105B, 105C, 105D (collectively or individually referred to with reference numeral 105) through cellular network 115 and/or WLANs (Wireless Local Area Networks) 130. Generally, interworking network 140 implements authentication among the multiple WLANs, and/or among one or more cellular networks, and thus allows terminal devices 105 to communicate with other devices that operate over disparate networks such as a cellular network or a WLAN. Interworking network 140 also anchors data sessions between terminal devices 105 to maintain communication between the devices. The interworking network 140 may also be in communication with an information source 133 via the Internet 131. The information source 133 may provide content such as videos, audio, text, web pages, or any other content that may be requested by a terminal device 105.

In one embodiment, interworking network 140 includes an operating center (OC) server 145 and an AAA server 150. The OC server 145 creates and maintains communication sessions for facilitating communication between terminal devices 105. Although only one OC server is shown, it is understood that a plurality of OC servers may be in communication with terminal devices 105 to create and maintain sessions in order to protect from session failure.

In one embodiment, a session comprises a plurality of attributes that describe the data type or media streams (e.g., audio or video) used in communication, the types of terminal devices 105 used in communication, roles of the terminal devices 105, and other local terminal devices available to the users. By managing communication sessions for the users, the OC server 145 allows for the users to communicate with contacts across disparate networks (i.e., cellular network 115 and WLAN 130) and services and to seamlessly switch between different types of terminal devices and/or different types of networks during communication.

For example, by managing a session of communication, the OC server 145 allows a user to initially use a cellular phone during communication and continue the communication using a VOIP phone at the discretion of the user without interrupting the ongoing conversation. In another example, by managing a session of communication, the OC server 145 allows terminal devices 105, such as a smart phone, to seamlessly switch between using the cellular network 115 and WLAN 130 for communication responsive to one of the networks providing better connectivity. The switch between cellular network 115 and WLAN 130 may be at the discretion of the user or may be made automatically requested by the terminal device 130 in order to provide better connectivity. Thus, session management by the OC server 145 allows for device mobility during communication as well as network mobility.

In one embodiment, users register with the OC server 145 in order to gain access to the functionality provided by the OC server 145 as described in the present disclosure. Registering with the OC server 145 may comprise downloading a client application (i.e., a user agent) to a terminal device 105 that functions as the user interface to the OC server 145. Registering with the OC server 145 may also comprise establishing an account with the OC server 145 by providing a username and password to the OC server 145. In some embodiments, payment information such as a credit card number may be required for the services provided by the OC server 145. In alternative embodiments, users are not required to register with the OC server 145.

AAA servers such as AAA server 150 are well known, so a detailed discussion is omitted. Briefly, the first “A” stands for authentication, which refers to the process performed by AAA server 150 of verifying a terminal device's claim to holding a specific digital identity, and typically involves providing credentials in the form of passwords, tokens, digital certificates, or phone numbers. The second “A” is for authorization, and is more properly termed “access control.” This functionality of the AAA server 150 grants or refuses access privileges. For example, a WLAN may grant a given terminal device access to the Internet but deny access to a proprietary database. Finally, the last “A” is for “accounting,” which refers to the tracking of the consumption of network resources, typically for purposes of billing. AAA servers are alternatively referred to herein as “authentication” servers, as some embodiments may dispense with other functionality.

In one embodiment, a terminal device 105A, such as a cellular phone, communicates with the interworking network 140 through a cellular network 115. In this example, terminal device 105A belongs to a user who has an account with a cellular provider that maintains the cellular network 115, or wireless wide-area network (WWAN), which conventionally includes cellular towers 120 and an AAA server 125. AAA server 125 is similar to AAA server 150 described above and performs similar functionalities. Towers 120 provide for wireless communication between terminal device 105A and cellular network 115, while AAA server 125 controls which terminal devices 105 have access to network 115, what level of service they receive, etc.

In one embodiment, terminal device 105B, such as a computer, may also communicate with the interworking network 140 through WLANs 130. Each WLAN 130 provides for wireless communication over an area that is limited relative to what is typically provided by cellular network 115. In this example each WLAN 130 is independently managed, with typical examples including enterprise networks and home networks. WLANs 130 include a wireless access point (WAP) 135 and an AAA server 137 that performs functionality similar to AAA 150. WLANs 130 may communicate with terminal device 105 using a different air interface than that employed by cellular network 115, and typically provide considerably higher data bandwidth and lower cost per byte of information, albeit within a much smaller coverage area. The networks depicted as clouds in FIG. 1 can be interconnected with one another and with other networks using proprietary connections or public resources, such as the Internet.

Each of the devices and networks of FIG. 1 can include many components that have been omitted from FIG. 1 for ease of illustration. For example, terminal device 105A can be a so-called “smart phone” that includes an application/media processor and associated memory to support web access, location-based services, multimedia applications, etc. Terminal device 105A may also be any device with computing capabilities. Terminal device 105A can also include numerous interfaces in support of wireless or wired communications, which commonly include a cellular interface, an infrared port, a Bluetooth wireless port, and a Wi-Fi wireless network connection. Terminal device 105A may also include a Global Positioning System (“GPS”) receiver.

Cellular network 115 is likewise far more complex then shown, and will typically include e.g. a Radio Access Network (RAN), which typically includes base stations and controllers, and a Core Network (CN), which typically includes multiple switching entities and gateways. These and other features of terminal devices 105 and cellular network 115 are well known to those of skill in the art. A detailed treatment is therefore omitted for brevity.

### Operating Center Server

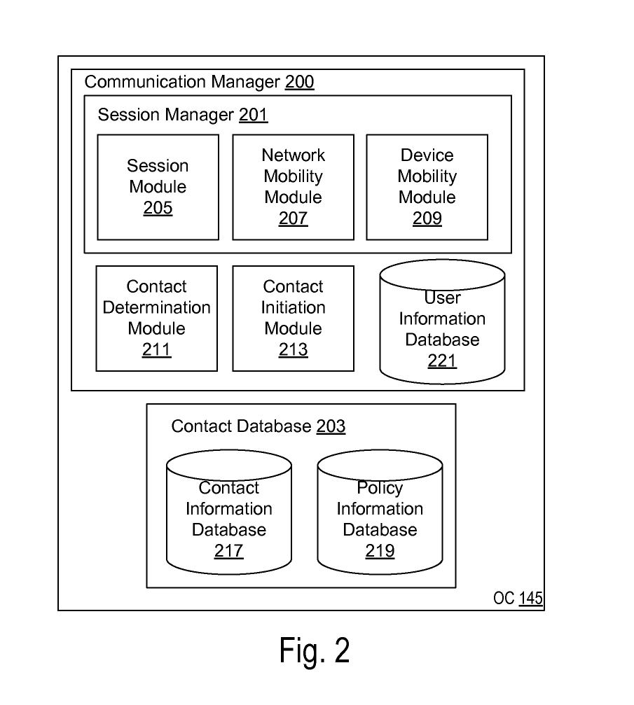

Referring now to FIG. 2, there is shown a high-level diagram illustrating the various functional software modules of the OC server 145 for session management according to one embodiment. As shown in FIG. 2, the OC server 145 includes multiple functional software modules that are in communication with one another. Note that other embodiments of the OC server 145 may have different and/or other functional software modules than the ones described here, and that the functionalities can be distributed among the modules in a different manner.

In one embodiment, the OC server 145 comprises a communication manager 200. Generally, the communication manager 200 facilitates communication between terminal devices 105, thereby allowing users to communicate with one another using disparate terminal devices (e.g., cellular phones, laptop computers, VOIP phones, and IP televisions) that may operate on different types of communication networks. According to one embodiment, the communication manager 200 comprises a session manager 201 that manages communication sessions between terminal devices 105. In one embodiment, the communication session comprises a plurality of attributes. The plurality of attributes describe the type(s) of devices being used during communication between users, how the terminal devices are connected to the OC server 145 (e.g., cellular network 115 and/or WLAN 130), the data types being communicated through the OC server 145, other terminal devices that are in the proximity of the devices being used in the communication, the role of each terminal device in the session, and the permissions to modify the session or parts of the session as will be described in further detail below.

According to one embodiment, the session manager 201 comprises a session module 205, a network mobility module 207, and a device mobility module 209. Each of the modules of the session manager 201 will be described in further detail below.

In one embodiment, the session module 205 creates and maintains communication sessions. The session module 205 may also store a communication session at the OC server 145 and/or at the terminal devices 105 included in a session. A communication session allows for communication between disparate terminal devices through the OC server 145. Responsive to a terminal device 105 logging onto the OC server 145 for communication, the session module 205 creates a communication session for the terminal device 105 that includes the attributes of the terminal device. That is, responsive to the client application of the terminal device 105 being in communication with the OC server 145, the session module 205 creates a communication session for the terminal device 105. The session module 205 also updates the communication session responsive to the terminal device being in communication with other devices through the OC server 145. Additional details on how the session module 205 creates and updates the session are provided below.

Furthermore, the session module 205 also maintains a log that describes events that occur during a communication session and the time of each event. For example, the log may comprise the time when the session was established and terminated, the time when another terminal device (i.e., a participant) was added to the session, the time when any files or data were sent/received between terminal devices, an indication of the terminal device(s) of the user that are included in the session, any URLs or media streams included in the session and any other events that may occur during communication. The session logs are stored by the OC server 145 so that any media streams included in the session may be temporarily suspended and re-started from the log file. Thus, a user may stop a communication session for some period of time and restart the session at a later time. The restarted session includes the media streams included in the session prior to suspension due to the log file being saved by the OC server 145. Furthermore, the session logs may be exposed to participants of the session based on the permissions grated to each participant as will be described in further detail below.

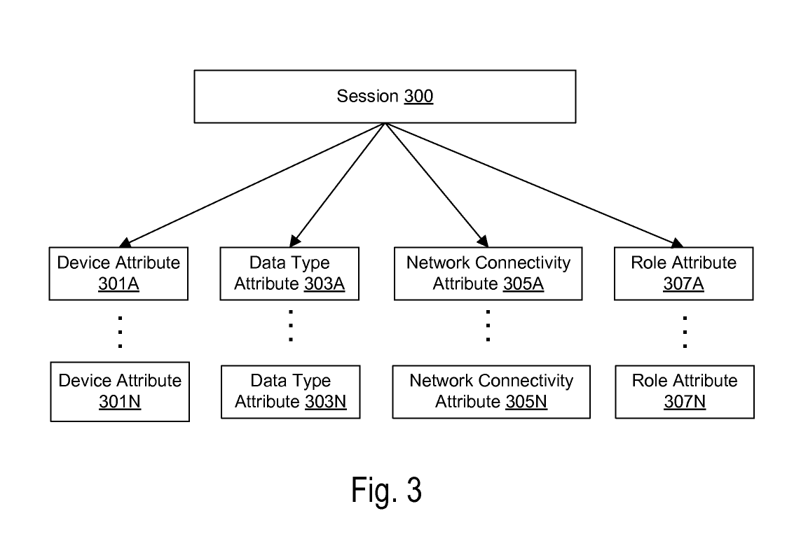

Referring now to FIG. 3, a session 300 is illustrated. In one embodiment, the session 300 comprises a device attribute 301, a data type attribute 303, a network connectivity attribute 305, and a role attribute 307. In one embodiment, the device attributes 301A-301N (individually or collectively referred to herein with reference numeral 301) describe the different terminal devices 105 included in a communication session. That is, each device attribute 301 is indicative of a terminal device 105 that is currently in active communication with another terminal device in the communication session 300. Thus, device attributes 301A through 301N describes the terminal devices 105 that are currently in communication with one another in the session 300. Note that a single user may have one or more terminal devices in the session 300. Accordingly, each device is represented by a device attribute.

In one embodiment, each device attribute 301 describes a terminal device associated with the attribute. The session module 205 may receive from a terminal device 105 a description of the capabilities of the device as well as the device type associated with the device (e.g., VOIP phone, cellular phone, computer, etc.). Examples of the capabilities may be the type of media streams capable of being sent and/or received by the terminal device (e.g., audio, video, and/or text), the type(s) of network that the device is capable of communicating on such as cellular networks or through Wi-Fi, hardware capabilities of the terminal device 105, etc.

In other embodiments, the OC server 145 may store device capabilities for various devices. The session module 205 may receive from a terminal device 105 a manufacture model number or model name of the device. From the model number or model name, the session module 205 may determine the capabilities of the terminal devices from stored information and use such information as part of the device attributes of the terminal device.

The session module 205 creates a device attribute for each terminal device based on the capabilities of the device. Additionally, because terminal devices may support communication over multiple types of communication networks, the device attribute may also indicate which network (e.g., cellular or WLAN) is currently being used to facilitate communication and/or identify the gateway or host (e.g., home internet service provider or work domain) through which the device accesses the network. The device attribute may also indicate an inactive communication network indicating other types of networks that the terminal device 105 may also be capable of communicating on when the device is connected to a network of that type.

In one embodiment, the device attribute also encapsulates the state of terminal devices during communication at any given point in time. The device attribute may describe the status of each terminal device included in the session. For example, “available,” “in conversation,” or “busy” may represent the different status of a terminal device 105.

In one embodiment, the data type attribute 303A-303N describes the data types for communication (i.e., a media stream) between the terminal devices 105 included in the session 300. In other words, the data type attribute 303A-303N describes the type of media communication being used between terminal devices described by device attributes 301A-301N. In one embodiment, a data type attribute may describe an audio data type, video data type, or messaging media type (e.g., email or text message) according to one embodiment. The data type attribute may also describe an advertising data type. The OC server 145 may insert advertisements into data streams communicated to terminal devices in an active communication session. The OC server 145 may insert advertisements based on location of the terminal device as well as based on user specific information included in the user information database 221.

In one embodiment, the session module 205 may create the data type attribute based on a contact policy of a recipient of communication. In one embodiment, the routing policy describes a set of rules defining how incoming messages are delivered to terminal devices of the recipient, as will be described in further detail below. For example, consider a user whose contact policy indicates that the user should be contacted only via video conference. Accordingly, responsive to receiving a request to contact the user, the session module 205 creates a data type attribute 303 for the audio stream portion of the video conference as well as a data type attribute 303 for the video stream portion of the video conference based on the contact policy. The data type attributes 303 for the audio stream portion and the video stream portion are added to the session 300 where each attribute is used by the OC server to communicate its respective data type with a terminal device. In one embodiment, a data type attribute 303 for each data type is created for each terminal device in the session 400 to describe the data type communicated with the OC server 145, and the data type attribute corresponding to the data type currently used by the terminal device 150 is added to the session 300 associated with the terminal device 150.

In one embodiment, the network connectivity attribute 305 describes other terminal devices that may be available for inclusion in the communication session at the request of the users associated with the terminal devices in the session 300. That is, the network connectivity attribute 305 describes other terminal devices that may be used in the ongoing communication other than the terminal devices that are current in communication via the OC server 145. The network connectivity attribute 305 describes other terminal devices that are within a short distance from the terminal devices in the active communication session. In one embodiment, distance is a matter of context. That is, whether a terminal device is a short distance from another device in the active communication session is based on the device type. For example, an IP television located in another room of a building from where an active terminal device is located would not be assigned a network connectivity attribute 305. However, a printer or VOIP phone only a few feet away from the active terminal device may be assigned a network connectivity attribute 305. The session module 205 may determine the location of terminal devices based on global positioning system (GPS) coordinates, known information about Wi-Fi access points, cellular uplink differential time of arrival (DTOA), IP geo-tags, or other means. As mentioned previously, during communication, a user may switch the method of communication from one terminal device to another (e.g., user's mobile phone to user's VOIP phone).

Accordingly, for each participant in the communication described by the session 300, the session module 205 determines the participant's local terminal devices that are currently online. The session module 205 determines the local terminal devices that are in proximity of the active terminal devices described by device attributes 301. In one embodiment, a local terminal device is online if the device has network connectivity through the cellular network 115 and/or the WLAN 130. For each local terminal device that is online and in proximity to an active terminal device, the session module 205 creates a network connectivity attribute 305. In one embodiment, each network connectivity attribute 305 includes an indication of an active terminal device (described by the device attributes 301) that is associated with the local terminal device described by the network connectivity attribute 305. The indication is indicative of which user is associated with local terminal device. The association allows the OC server 145 to provide a correct listing of local terminal devices to the appropriate active terminal device of the user that is associated with the local devices.

In one embodiment, the role attribute 307A-307N describes the responsibility for each terminal device described by the device attributes 301. Generally, the session module 205 assigns the role of session owner (master) or the role of session guest (slave) to a terminal device in a session. Typically, the session module 205 assigns to the terminal device(s) associated with the initiator of the communication the role of session owner whereas the recipient of the communication is assigned the role of session guest.

However, in one embodiment, the session module 205 may change the role of session owner at the discretion of the initiator of the communication. In one embodiment, the session module 205 may receive an instruction from the terminal device associated with the role of session owner delegating the role of session owner to the terminal device(s) of the recipient.

The roles of terminal devices define which terminal device(s) are capable of assigning the permissions of communication to the terminal devices described by the device attributes 301. That is, the owner of the session 300 determines the communication permissions granted to the terminal devices in the session 300. In one embodiment, permissions are granted to individual media streams described by the data type attributes 303 where each stream is associated with an access control list (ACL). The ACL describes the communication permissions of terminal devices in the session and describes which streams are exposed to particular terminal devices in the session.

For example, consider a video conference between a first terminal device and a second terminal device that is facilitated by the OC server 145. In this example, the first terminal device is associated with “session owner” and thus defines the permissions described by the ACLs for the audio stream and video stream of the conference. The ACL for the audio stream portion of the video conference may indicate that both the first terminal device and second terminal device have permission to speak and listen during the video conference. However, the ACL for the video stream portion of the video conference may indicate that only the video stream from first terminal device may be transmitted to second terminal device, but the second terminal device cannot transmit a video stream to the first terminal device.

In another example, consider a telephone call between a first terminal device and a second terminal device that is facilitated by the OC server 145. One of the users in the communication session that has been granted permission to add data to session (i.e., write permission) may add a URL to the call. By adding the URL to the call, content from the resource specified by that URL is displayed on both the first and second terminal devices while the call is active. In one embodiment, any user with the write permission may add the URL to the call. For example, the session owner may only be allowed to add data to the call or both the session owner as well as the other user in the call may add the URL to the call.

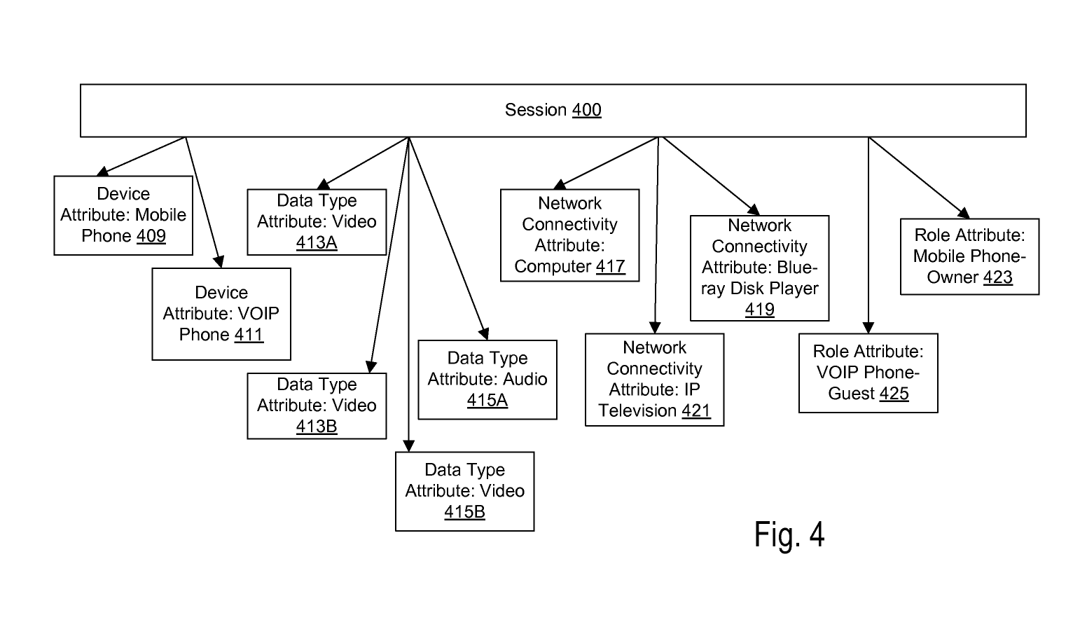

Referring now to FIG. 4, there is shown one example of an established session 400 of communication created by the session module 205. Session 400 comprises device attributes 409 and 411 that respectively indicate that a mobile phone 409 is currently in communication with a VOIP phone 411 through the OC server 145. Although not illustrated in FIG. 4, device attributes 409 and 411 also indicate the respective capabilities of the mobile phone and VOIP phone and the type of communication network being used to connect to the OC server 145. For example, the mobile phone's capabilities may comprise the capability of communicating using voice communication, video communication, SMS messaging, and/or email and being capable of operating over the cellular network 115 and/or WLAN 130. In contrast, the VOIP phone's capabilities may comprise the capability of communicating using voice communication and video communication using only WLAN 130.

Session 400 also comprises data type attributes 413 and 415 that indicate the types of media streams being used during the communication between the mobile phone and VOIP phone. In this example, the data type attributes 413 and 415 respectively indicate that the mobile phone and VOIP phone are communicating using a video stream as well as an audio stream. Thus, the devices are in communication through a video conference in this example. Specifically, each device attribute 409 and 411 has its associated data type attribute. In this example, data type attributes 413A and 415A indicate that the mobile phone is communicating the data types of audio and video to the OC server 145. Similarly, data type attributes 413B and 415B indicate that the VOIP phone is communicating the data types of audio and video to the OC server 145.

Note that in different communication scenarios, the data type attributes of the devices in communication need not correspond as shown in the example described above. For example, consider the scenario where a user initiates a call to the OC server 145 that indicates that the recipient of the call only receives email based on a transcription of the call. Thus, the user provides a message that is transcribed into text. Accordingly, the data type attribute for the terminal device of the user initiating the call is audio data type whereas the date type attribute for the terminal device of the recipient of communication is a textual data type.

Network connectivity attributes 417, 419, and 421 describe the local terminal devices that are proximate to the mobile phone 409 and VOIP phone 411. In this example, a computer 417, a blu-ray disk player 419, and IP television 421 are local to mobile phone 409 and VOIP phone 411. Although not illustrated in FIG. 4, each network connectivity attribute is associated with a specific device attribute. The association describes which local terminal device is proximate to mobile phone 409 and VOIP phone 411. For example, the computer 417 and IP television 421 may be in the proximity of the mobile phone 409 whereas computer 419 is local to VOIP phone 411.

The session 400 also includes role attributes 423 and 425 that indicate the roles for mobile phone 409 and VOIP phone 411. In this example, the mobile phone is associated with the session owner role 423 whereas the VOIP phone is assigned the guest role 425. Thus, the user of the mobile phone defines the communication permissions for the session 400. For example, the user of the mobile phone 409 may indicate that both the mobile phone 409 and the VOIP phone 411 are capable of transmitting and receiving video streams and audio streams. Accordingly, the session module 205 creates an ACL for each stream based on the permissions indicated by the user of the mobile phone 409.

Referring back to FIG. 2, in one embodiment the session manager 201 comprises a network mobility module 207. The network mobility module 207 moves an active communication session from one communication network to a different communication network. In one embodiment, the terminal device 105 may monitor other types of network connections for a better (i.e., faster) connection and may submit a request to the OC server 145 to switch the session to the better network connection.

Responsive to receiving the request, the network mobility module 207 determines the quality of the connection. That is, the network mobility module 207 determines whether the network connection can support the data types in the communication session and offers better performance (e.g., speed, latency or bandwidth) than the current network technology being used to facilitate the communication. In one embodiment, the network mobility module 207 determines the quality of the connection based on received signal strength indication (RSSI) measurements or through quality of service (QoS) measurements. Responsive to determining that the new network connection may support the communication and offers better performance, the network mobility module 207 registers the terminal device 105 with the new communication network and authenticates and authorizes the connection with the new communication network. The network mobility module 207 also communicates with the session module 205 to update the attributes of the session based on switching between the different types of communication networks.

In alternative embodiments, the network mobility module 207 may monitor different networks (e.g., cellular network 115 and WLANs 130) to determine the optimal network connection for the communication session. Responsive to determining an optimal connection, the network mobility module 207 may automatically move an active communication session from one communication network to a different communication network. Alternatively, the network mobility module 207 may jointly use both communication networks to provide the optimal network connection for the session.

In one embodiment, the session manager 201 also comprises a device mobility module 209 that facilitates the ability for a user to move his or her active communication session from one terminal device to another terminal device (e.g., cell phone to VOIP phone). The migration of the session is performed by the device mobility module 209 such that all other participants in the communication are not aware of the migration from one terminal device to another. That is, the other participants in the communication session do not experience an interruption in connectivity as the device mobility module 209 migrates the session between terminal devices.

The device mobility module 209 receives a request from a user's terminal device 105 to migrate an active session from a first terminal device to a second terminal device associated with the user. For example, the user may request to switch a call from his or her cellular phone to his or her VOIP phone or even to another cellular phone. Responsive to receiving the request, the device mobility module 209 determines the availability of the second terminal device in which to move the session. That is, the device mobility module 209 determines whether the second terminal device is available to the user based on the user's policy and whether the device is currently being used in another session.

Additionally, the device mobility module 209 receives authorization to migrate the session from the user agent of the first device prior to session migration because the second terminal device may have more or fewer capabilities than the first terminal device initiating the session migration. In one embodiment, the device mobility module 209 determines the capabilities of the second terminal device. Responsive to the terminal device having fewer capabilities than the first terminal device, the device mobility module 209 transmits a message to the user agent of the first terminal device indicating the restrictions of communication that result from the migration of the session to the second terminal device according to one embodiment. The message may describe the features of communication that may be unavailable as a result of the migration and requests authorization (i.e., confirmation) of the migration.

For example, the user may currently be participating in a video conference via a computer, but transmits a request to switch the session to his or her cellular phone that only supports audio communication. Thus, the migrated session will be restricted (i.e., limited) to audio communication rather than video and audio communication. The device mobility module 209 transmits these restrictions to the user's computer and requests authorization of the migration to the cellular phone.

However, in one embodiment note that the device mobility module 209 only allows session migration if the restrictions that result from the migration do not materially disrupt the session. For example, the device mobility module 209 may deny a request to transfer a conversation from a cellular phone to an IP television that does not have a connected microphone. Allowing the migration would result in a lack of communication between the participants in the session because there is no way for the IP television to communicate audio with other participants.

In one embodiment, the device mobility module 209 may also transcode a session in order to display data types on terminal devices of different capabilities. Thus, the session may be distributed over multiple devices. In one embodiment, the OC server 145 may transcode media streams such as audio or video by reformatting the media streams to be compatible with a new terminal device associated with a session migration request. The device mobility module 209 may also transcode a session by determining a plurality of terminal devices that are capable of supporting the media streams of a session based on the capabilities of the devices. By transcoding a session, communication restrictions are alleviated by transmitting media streams of different types to different termination devices that can support the streams.

For example, consider a request to migrate a video conference from a computer to a cellular phone that is not capable of handling a video conference and can only handle audio streams. The device mobility module 209, may determine that a second local terminal device is available that is capable of receiving video streams, such as an IP television. The device mobility module 209 may transcode the session such that the audio stream is directed to the cellular phone whereas the video stream is terminated at the IP television. In alternative embodiments, the device mobility module 209 may receive a request from a user agent of a terminal device to transcode the session so that media streams are sent to disparate devices. That is, the user may specifically request to transmit an audio stream to the cellular phone and the video stream to the IP television in the example described above.

Responsive to the second terminal device having additional capabilities not provided by the first terminal device, the device mobility module 209 transmits an indication to the first terminal device of these capabilities. Thus, if the session contains data types that the second terminal device can now render or the ability to broadcast data types that were not possible to broadcast is now present, the user agent receives an indication (e.g., a message) from the device mobility module 209 comprising a clarification of the additional capabilities. Thus, the user of the device will be aware of the different types of communication that can now be performed as a result of the migration.

Responsive to the second terminal device being available for communication and the user authorizing the migration of the session, the device mobility module 209 initiates communication with the second terminal device (e.g., calls the VOIP phone). The device mobility module 209 adds the second terminal device to the session that includes the other participants and disconnects the first terminal device that initiated the request for device mobility.

Additionally, the device mobility module 209 communicates with the session module 205 to update the communication session with the attributes of the terminal device to which the session was migrated. In one embodiment, the attributes of the first terminal device that was disconnected are removed from the session. However, in alternative embodiments the attributes of the disconnected device may be maintained in the session with an indication that the device is inactive.

In one embodiment, the communication manager 200 further comprises a contact determination module 211 and a contact initiation module 213. The contact determination module 211 determines the communication mechanism(s) in which to contact a user based on a user's contact policy and user profile. Responsive to receiving a request to communicate with one of a user's contacts, the contact determination module 211 accesses the user's profile and contact policy. From the user's contact policy, the contact determination module 211 determines which communication mechanism(s) should be used to communicate with the contact. For example, the contact policy for the recipient of the communication may specify to call the recipient's mobile and work phones. The contact determination module 211 then accesses the user profile of the recipient to determine the communication identifiers associated with the mobile and work phones.

In one embodiment only a single identity of the user may be exposed based on the recipient's contact policy such as an email address. Thus, the communication request may be in the form “Call j.doe@rambus1.com” or “Email 650-947-5000” or “IM Jdoe111” where Jdoe111 is an Online Gaming Community user name. Because only a single identity (i.e., the email address j.doe@rambus1.com, the telephone number 650-947-5000, or the online gaming community user name Jdoe111) for the recipient is exposed, but several communication mechanisms may exist to contact the recipient associated with the identity, the format of the identity is decoupled from the communication mechanism associated with the identity.

In the first example above, the identity is in the form of an email address (j.doe@rambus1.com), but a request for communication with the user associated with the identity may be a request to call the email address, which is translated by contact determination module 211 to a request to a call a telephone number associated with the user that is not exposed to other users based on the contact policy. In other embodiments, the exposed identity may be completely hidden such that only “Call J. Doe” is exposed with no mention of the communication means.

The contact initiation module 213 initiates communication between terminal devices according to one embodiment. In one embodiment, a first client on the initiating terminal device 105 communicates with a second client the recipient's terminal device through the OC server 145. The OC server 145 communicates with the second client on the recipient's terminal device through either the cellular network 115 or the WLAN 130. Once the OC server 145 has established communication with the second client, the recipient's terminal device is added to a conference comprising the initiating terminal device thereby allowing communication between the devices. Whether the cellular network or WLAN 120 is utilized depends on what form of communication is used to contact the recipient. By having the OC server 145 communicate with the second client on the recipient's terminal device, the OC server 145 functions as a proxy for communication between the initiating terminal device and the recipient's terminal device.

As described above, the initiating terminal device 105 communicates with the recipient's terminal device through the OC server 145. Thus, any media streams sent by a first terminal device are received by the OC server 145. The OC server 145 communicates the media streams from the first terminal device to the intended recipient (i.e., a second terminal device). The OC server 145 communicates with the recipient's terminal device through either the cellular network 115 or the WLAN 130. Once the OC server 145 has established communication with the recipient's terminal device, the recipient's terminal device is added to the session comprising the initiating terminal device thereby allowing communication between the devices.

For example, if the recipient's policy states to call the recipient via a VOIP service, the OC server 145 establishes a communication path through a WLAN 130. In another example, if the recipient's policy states to call the recipient's mobile phone, a communication path through the cellular network 115 is created.

In alternative embodiments, the initiating terminal device contacts a recipient's terminal device directly. Rather than the OC server 145 acting as a proxy, the contact initiation module 207 provides instructions to the terminal device 105 to directly contact a recipient's terminal device. Thus, media streams are directly served between terminal devices 105. In one embodiment, the OC server 145 receives a request from the initiating terminal device to communicate with another user. The OC server 145 transmits a message to the initiating terminal device with suggestions on how to contact the recipient in accordance with the recipient's contact policy and availability. In one embodiment, the user of the terminal device selects one of the contact means suggested by the OC server 145 in order to contact the recipient causing the terminal device to contact the selected communication means.

In one embodiment the communication manger 200 further comprises a user information database 221. The user information database 221 comprises user specific information. For each user, the user information database 221 may store information such as bookmarked web pages, favorite web pages (i.e., favorite URLs), favorite terminal devices 105 for communication, and any other user specific information. As shown in FIG. 2, the user information database 221 may be included in the OC server 145. However, in alternative embodiments the user information database 221 may be located separate from the OC server 145.

As shown in FIG. 2, the OC server 145 also comprises a contact database 203. Generally, the contact database 203 maintains contact information and user identities of users registered with the OC server 145. In one embodiment, the contact database 203 comprises a contact information database 217 and a policy information database 219. The contact information database 217 stores contact information for each registered user. The contact information may comprise the user's contacts (i.e., contact information of others) as well as the user's own personal contact information.

Due to the various types of communication platforms that are now available, the user may be contacted via different forms of communication using terminal devices that operate on disparate networks. The contact information database 217 stores for each user a profile that describes the user's personal contact information. In one embodiment, a user's contact profile describes the user's contact information that represents the various identities of the user that are used to communicate via different types of communication means such as email, SMS messaging, or VOIP calls. According to one embodiment, addressable devices such as Blu-Ray players or IP televisions may also be associated with an identity of a user.

In one embodiment, the contact information is a communication identifier such as an email address, telephone number, a message handle, or username. As mentioned previously, each communication identifier represents the user's identity in the service that provides the communication means. For example, the user's VOIP service handle represents the user's identity in the VOIP service network of users. According to one embodiment, a user profile may comprise one or more of the following exemplary communication identifiers for a user:

work email address;

personal email address;

mobile phone number;

home phone number;

work phone number;

pager number;

VOIP service username (i.e., handle);

Instant Messenger service identifier;

VOIP phone number;

social networking service username;

online gaming name

Note that any other form of contact information that may be used to contact the user other than those listed above may be included in a user profile. Additionally, the user profile may comprise the user's avatars or user headshots that are associated with each identity. In one embodiment, an avatar may be the user's computer representation in the form of a three-dimensional model or a two-dimensional icon or picture presented to other users of a particular communication service. For example in the context of an Instant Messenger message to a recipient, in addition to presenting username to the recipient of the message, a picture of the user (i.e., an avatar) may also be presented. Furthermore, the user profile may comprise one or more voice-overs that modify the user's voice to produce an alternative voice such as a cartoon character voice.

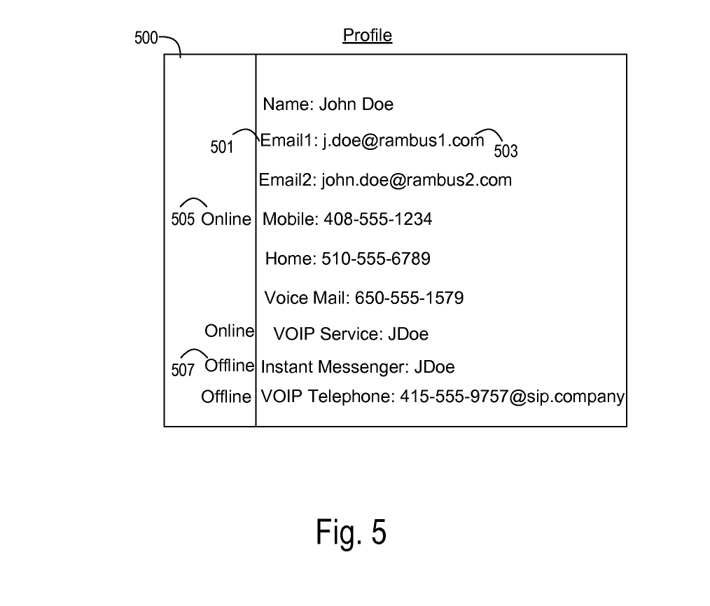

Referring now to FIG. 5, there is shown one example of a user profile for user “John Doe” according to one embodiment. The user profile comprises a list of contact fields that describe the types of communication that may be used to contact the user identified by the profile, and is stored in contact information database 217 (FIG. 2). Each contact field has an associated contact value. The contact value describes the communication identifier associated with the type of communication specified by the contact field. In one embodiment, the contact value may also include the credential, certificate, or password that allows user access to the particular communication means associated with the value. As mentioned above, the contact value describes the user's identity in the service that provides the type of communication associated with the contact field. For example, contact field 501 is associated with email communication and the contact value 503 “j.doe@rambus1.com” represents the address of an email box provided by an email service in which the user's email is delivered.

In one embodiment, the user profile further comprises a device status for the terminal devices associated with the contact information where applicable. As previously discussed, according to one embodiment, the user's terminal devices may comprise a user agent that is used to interface with the OC server 145. The user agent may communicate with the OC server 145 to indicate the status of the device. By communicating with the terminal device, the OC server 145 is aware if the device is “online.” In one embodiment, a device is online if the device is able to communicate with the OC server 145 via the cellular network 115 and/or the WLAN 130. In alternative embodiments, to determine which terminal devices 105 are online, the OC server 145 may poll each device. If a response is received from a terminal device 105 being polled, the OC server 145 determines that the terminal device is online.

In the example profile 500, the profile 500 indicates that the user's mobile phone is currently online 505. That is, the mobile phone currently is capable of communicating with the OC server 145. In contrast, the user's IM messager is currently offline 507 indicating that the user is not currently signed onto the instant messager service. Although not shown, the device status may also include an indication that describes whether the terminal device is currently being used in another session.

Referring back to FIG. 2, in one embodiment the contact database 203 also comprises a policy information database 219. The policy information database 213 comprises contact policies for users that describe how incoming communications are routed and delivered. Each contact policy is associated with its corresponding user profile stored in the contacted information database 217. In one embodiment, a user's contact policy comprises the user's preferences describing how the user is presented to his or her contacts as well as the manner in which the user may or may not be contacted. Note that in other embodiments a contact policy may also comprise preferences other than those described below.

As mentioned above, typically a user is associated with multiple identities (e.g., email, IM username, VOIP service username, etc.) and may not want to expose all the user's identities to every contact. The contact policy may comprise a specific identity that the user allows exposure to all of his or her contacts. For example, the user may only want to expose an email address or a telephone number to his or her contacts which may be considered a “public” identity. In one embodiment, the contact policy may expose a specific identity to specific contacts. For example, the user may only expose a work email address to colleagues from work or may expose the identity “Dad” to his children or may expose the identity “BatmanForever” only to contacts that are part of a particular online gaming community. These identities are considered “Private” identities. Thus, in a user's contact list, each contact in the list is presented in the user's contact list based on the preferences indicated in the policy of the user's contact. Additionally, during communication, each user is presented to his or her contacts in a manner that is specified by the user's contact policy.

The contact policy also describes the communication mechanism(s) in which the user is contacted by his or her contacts. In one embodiment, the contact policy describes which communication mechanisms are used to contact the user based on the communication type initiated by a contact. That is, the contact policy describes actions to perform in response to receiving communication. For example, the user may indicate a preference that for any calls (i.e., the communication type) directed to the user's exposed identity, the user's mobile phone, home phone, work phone and VOIP telephone are called and an email is sent to the user's personal email address. Alternatively, the user may indicate a preference that any incoming emails should be sent to a specific email address. Additionally, the contact policy may describe forwarding messages to a specific voice mail box or forward incoming email messages to a specific email server.

In one embodiment, the contact policy may also include a preference describing who is allowed to communicate with the user. The contact policy may allow all of the user's contacts to communicate with the user, but not allow any calls to/from specific numbers such as “900” or “976” numbers or to/from domains such as a firewall for a user's phone. Thus, the contact policy may restrict any incoming communication from specific telephone numbers, email addresses, or domain addresses, or user identities.

The contact policy may also describe which types of communication are allowed or prohibited to be performed from a terminal device. For example, a mobile phone may only allow outgoing calls to a user's parents if the user is a child. In this example, the OC server 145 operates as a communication nanny for children any may only allow outgoing calls to all identities for “Mom.” Alternatively, the policy may indicate that only outgoing emails from a work computer or work mobile phone may be sent to an email address comprising a work domain address (e.g., @Rambus.com) to ensure that emails are work related.

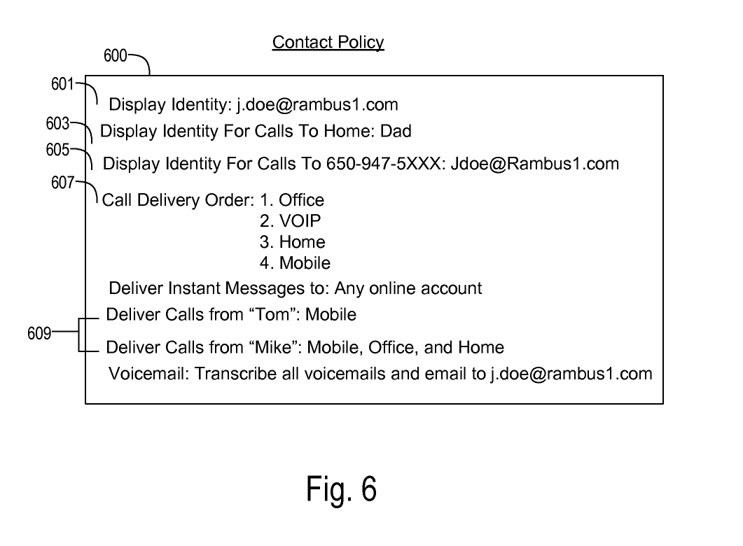

Referring now to FIG. 6, there is shown an example contact policy 600 according to one embodiment. The contact policy 600 illustrates examples of contact preferences for the user associated with the policy. In contact policy 600, the user set the display handle preference 601 so that the identity “j.doe@rambus1.com” is exposed to the user's contacts. The contact policy 600 also indicates a display identity preference for a specific scenario. In this example, the display identity preference 603 indicates to display the identity of “Dad” for any calls to the user's home telephone number. Additionally, a display preference 605 indicates to display the identity “Jdoe@Rambus1.com” for any calls to the number 650-947-5XXX. The contact policy also includes a call delivery order preference describing the order in which calls should be placed to the user. In this example, call delivery order preference 607 indicates that all calls should be sent to the user's office telephone number, VOIP service account, home telephone, and mobile cell phone number in that order. Furthermore, the contact policy describes preferences with respect to communication from certain contacts 609. In this example, all calls from the identity “Tom” are only sent to the user's mobile device whereas calls from the identity “Mike” are sent to the user's mobile device, office telephone number, and home phone number.

### Communication Protocol

As discussed above, the OC server 145 allows disparate terminal devices to communicate with one another through the OC server 145. These terminal devices may not be designed to communicate with each other. That is, an existing path of communication between the different types of terminal devices may not exist. In order to communicate with the different terminal devices 105, in one embodiment the communication manager 200 of the OC server 145 may function as a bi-directional chat server in order to control the devices for communication. That is, the communication manager 200 serves as a control channel for controlling terminal devices 105 during communication.

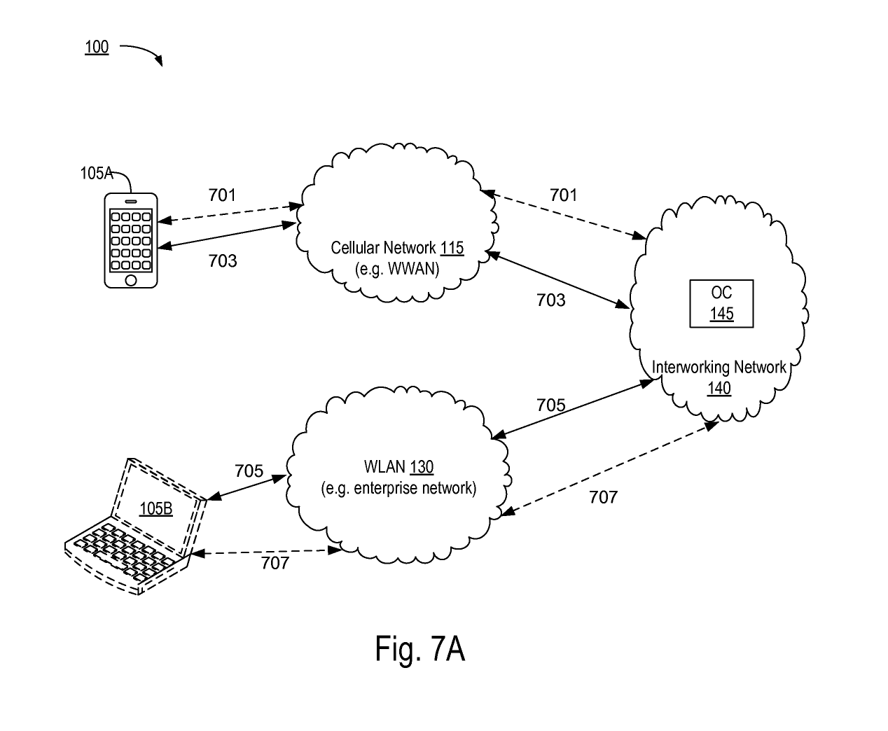

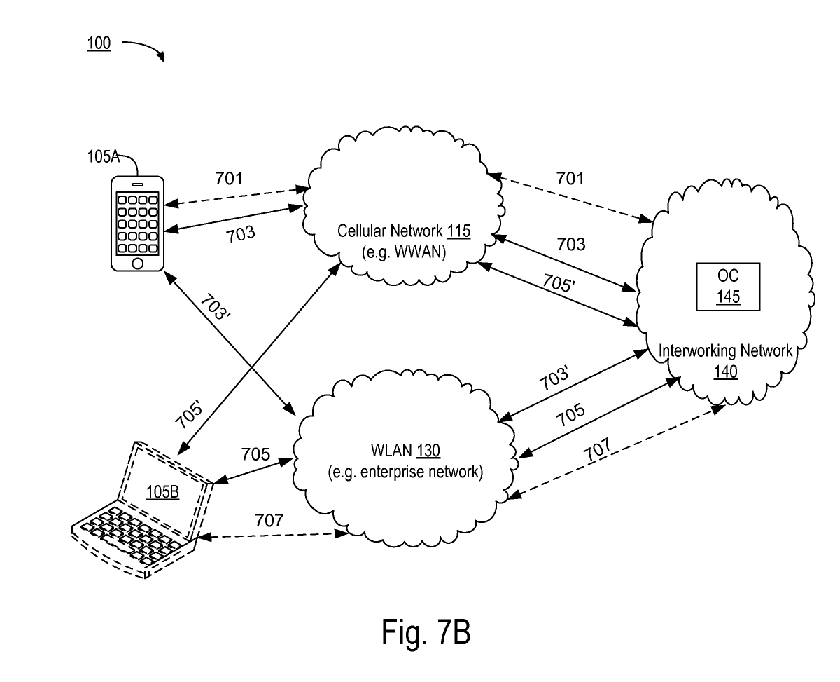

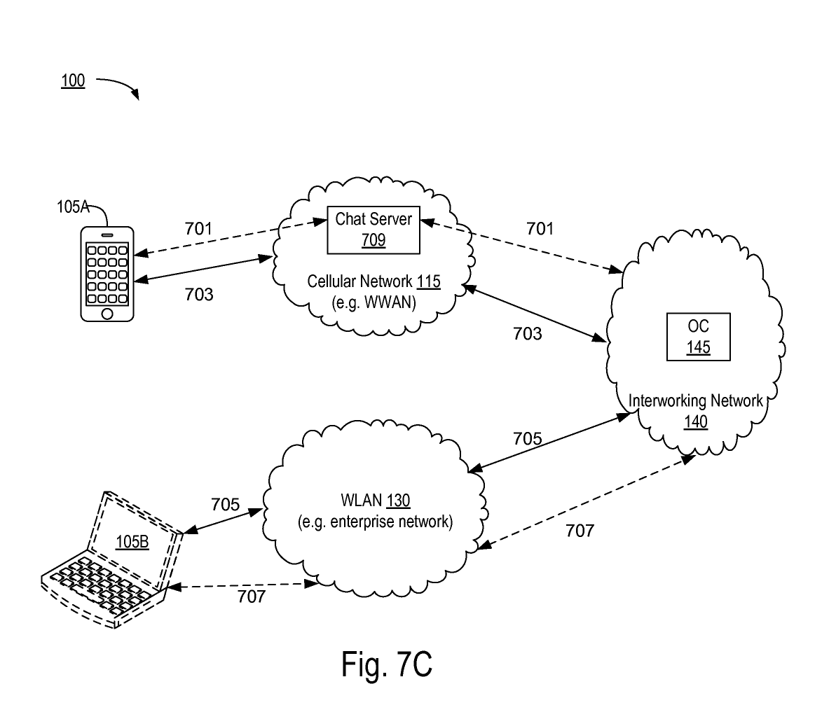

In one embodiment, the communication manager 200 communicates with user agents of terminal devices 105 through a sideband channel of a communication network (e.g., cellular network 115 and/or WLAN 130), as will be described in further detail below with reference to FIG. 7A, using an established control language or protocol. The control language allows user agents of the different types of devices to communicate with the communication manager 200 regardless of device type, through the OC communication manager 200. Any available messaging type may be used by the communication manager 200 such as extensible messaging and presence protocol (XMPP), session initiation protocol (SIP) or short message service (SMS) or through the decoding of dual-tone multi-frequency (DTMF) signals such as tones from a telephone keypad for communication with the terminal devices 105 according to one embodiment. In one embodiment, the audio and video streams of a communication session may be communicated through a LAN while the control messages between the client and the OC server 145 occur over a separate communication channel such as a cellular data call or SMS for example.

As described above, the communication manager 200 may use DTMF signals for communication with terminal devices 105. The use of DTMF signals allow a terminal device 105 to transmit instructions and messages to the OC server 145 responsive to the terminal device 105 lacking a data connection or responsive to the terminal device 105 lacking smart phone capabilities (i.e., is not a smart phone). Additionally, DTMF signals may be used when a terminal device 105 with smart phone capabilities (i.e., a smart phone) lacks access to a data network. In either of these scenarios, the OC server 145 may receive from the terminal device 105 DTMF signals that are interpreted by the OC server 145 as messages to control the communication session.

The following are example message types used by the communication manager 200 for facilitating control of terminal devices 105:

Presence

Transport Control Content

Content Provider

Billing

Localization

Personalization

Statistics

Logging

Synchronization

Session Management

Role/Authority Assignment

Device Availability

In one embodiment, the presence message type describes the location of a terminal device 105. In one embodiment, device locations may be determined by exposing global position system (GPS) coordinates of the terminal devices. Device locations may also be determined from IP geo-routing tags, or through in-building zone or area based location services and/or from authentication by a third-party with a known location to the OC server 145, or through known information about the pre-stored location of an application that broadcasts a service set identifier (SSID).

According to one embodiment, the transport control message type describes the transport mechanism used for communication between terminal devices 105 that are in communication with the OC server 145. That is, the transport control message type indicates the network being used by a terminal device 105 for communication with the OC server 145 and whether the terminal device 105 is switched between different networks for the communication. For example, the OC server 145 may receive from the terminal device 105 a transport control message indicating that the terminal device 105 switched from using the cellular network to using Wi-Fi for communication with the OC server 145.

In one embodiment, the content provider message type indicates the content provider used by the terminal device 105 for communication. That is the content provider message is indicative of the service provider (e.g., cellular phone carrier) for the terminal device 105.

The billing message type describes criteria that determine how much a user of a terminal device 105 is charged for the services provided by the OC server 145, according to one embodiment. The OC server 145 may provide customer billing information to the terminal device 105 via a billing message. For example, the user of the terminal device 105 may be charged for every instance of communication with the user's contacts through the OC server 145. Accordingly, the terminal device 105 may receive a billing message from the OC server 145 at the end of each billing period (e.g., end of each month) with the total number of communication instances facilitated by the OC server 145.

In one embodiment, the localization message type converts data into a format that is applicable for a specific geographic region. For example, in the United States the date format is typically “Month-Day-Year” whereas in Europe the date format is “Day-Month-Year.” Based on the geographic location of the terminal device 105, a message of this type may be communicated to/from the OC server 145.

In one embodiment, the personalization message type describes any updates to the user's own user profile or the user's contact list. The message type may also include personalization information about the user that is retrieved from the user information database 221. For example, a personalization message may include additions or changes to the user's favorite communication devices and the associated properties and capabilities of the devices.

In one embodiment, the statistics message type describes various communication statistics of the terminal device 105. For example, the statistics message type describes the speed in which the terminal device 105 and OC server 145 are in communication. For example, the OC server 145 may transmit a file of a predetermined size to the terminal device 105. In response, the terminal device 105 may communicate a statistics message indicating the total duration needed to download the file of the predetermined size.

In one embodiment, the logging message type describes events that have occurred on terminal devices 105 such as any initiated or received communications with other terminal devices or the length of communication or any failed communications. The OC server 145 may periodically receive from the terminal device 105 a log of the events that occurred on the terminal device 105. The log file may be exposed to all or in part to the participants of an active communication session. As described previously, a log file may be exposed to participants of the session based on the permissions granted to each participant. Furthermore, a session log may be exposed to a service technician of the OC server 145 to debug the session information if any session errors occur.

In one embodiment, the synchronization message type describes commands to synchronize communication with one or more additional devices. For example, a user of a mobile terminal device currently in communication with another mobile terminal device may want to synchronize the audio of the communication to the speakers of the user's vehicle. The OC server 145 may receive from the mobile terminal device a synchronization message with appropriate instructions.

In one embodiment, the session management message type describes communication between terminal devices 105 and OC server 145 regarding authentication/authorization for communication with the OC server 145. For example, a terminal device 105 may provide user credentials to the OC server 145 when logging onto the OC server 145 for communication services using a message of this type.

In one embodiment, the role/authority assignment message type describes communication permissions for terminal devices 105 in communication with one another. The OC server 145 may transmit a role/authority assignment message type to a first terminal device that it is the owner of a communication session and may transmit a message to second terminal device in communication with the first terminal device that it is a participant in the session. For example, consider a video conference facilitated by the OC server 145 where multiple clients in the call are connected via the OC server 145. During the video conference, by being an owner of the communication session, the associated terminal device may have the authority to indicate that the audio and video of the terminal device be provided to all other participants in the communication. However, in that example, other terminal devices in the video conference that are designated as participants or guests may only receive the audio and video initiated by the owner, but may not initiate audio and/or video to the owner. In another example, the session owner may grant other participants permission to transmit audio and/or video or include/remove any URLs during the video conference.

In one embodiment, the device availability message type describes whether a terminal device 105 is available for communication. Once a terminal device 105 is logged on the OC server 145, the terminal device 105 may transmit its communication status to the OC server 145 indicating whether it is available for communication (e.g., on) or if it is currently in communication with another terminal device. Additionally, the OC server 145 may transmit a device availability message to terminal devices to poll whether the devices are available for communication.

Referring now to FIG. 7A, there is shown a detailed view of the network system 100 illustrating the sideband channels according to one embodiment. Note that some elements of the network system 100 illustrated in FIG. 7A have been omitted for clarification purposes. As explained above, in one embodiment, these sideband channels may be implemented using a chat server exchanging chat messages between the OC server 145 and the terminal devices 105A, 105B.

In the network system 100, OC server 145 is in communication with client 105A through the cellular network 115 and is in communication with client 105B through the WLAN 130. In one embodiment, the data types (e.g., audio) transmitted between the OC server 145 and terminal device 105A are communicated via a primary channel 703 of the cellular network 115. For example, the audio streams of a voice call are transmitted through the primary channel 703 of the cellular network 115. However, the OC server 145 and the client 105A communicate with one another over a sideband 701 of the cellular network. That is, the communication messages described above to control client 105A are transmitted/received over the sideband 701 of the cellular network 115.

Similarly, in one embodiment the media streams transmitted and received between OC server 145 and terminal device 105B are communicated via the primary channel 705 of the WLAN 130. However, the OC server 145 and the client 105B communicate control messages with one another over a sideband 707 of the cellular network 130.

In an alternative embodiment, both client 105A and client 105B may be in communication with the OC server 145 using simultaneously both the cellular network 115 and WLAN 130. Referring now to FIG. 7B, client 105A may be in communication with the OC server 145 through the cellular network 115 using primary channel 703 as well as through the WLAN 130 using primary channel 703′. Similarly, client 105B may be in communication with the OC server 145 through the WLAN 130 using primary channel 705 as well as through the cellular network 115 using primary channel 705′.

Referring now to FIG. 7C, an alternative embodiment of a detailed view of the network system 100 illustrating the sideband channels is shown. The features illustrated in FIG. 7C are similar to those described in FIG. 7A. However, FIG. 7C illustrates a chat server 709 (e.g., a SMS server) included in cellular network 115. The chat server 709 provides communication messages used to control terminal device 105A through the sideband 701 of the cellular network 115.

### Interaction Between OC Server and Terminal Devices

Generally, when a user initiates an outgoing call to a recipient's handle, the user agent on the user's terminal device communicates to the OC server 145 the user's request to call the person associated with the handle. To communicate with the OC server 145 regarding the request, the user agent on the user's terminal device re-directs the terminal device's native dialer to contact the OC server 145. The OC server 145 then initiates communication with the user agent on the recipient's terminal device once the request is received. The OC server 145 then connects the call to the user initiating the request. Thus, even though the user called the handle, the user agent on the terminal device intercepts the call and directs it to the OC server 145.

In the scenario where an incoming call is directed to a recipient's exposed handle, the communication is also first received by the OC server 145. The OC server 145 communicates with the user agent on the recipient's terminal device to initiate a call to the OC server 145. Responsive to the call being received by the OC server 145, the OC server 145 connects the user initiating the call and the recipient of the call. If the user agent on the recipient's terminal device does not respond, the OC server 145 may directly call the recipient over either the public switched telephone network (PSTN) or some other available network. If the user agent does not respond to these or other attempts, the incoming call is directed to voicemail. If multiple calls are received for the recipient at the OC server 145, the OC server may present the recipient with a choice as to which communication he or she wants to accept and may direct the other communications to voicemail or to another party. The other communications may also be in conference together.

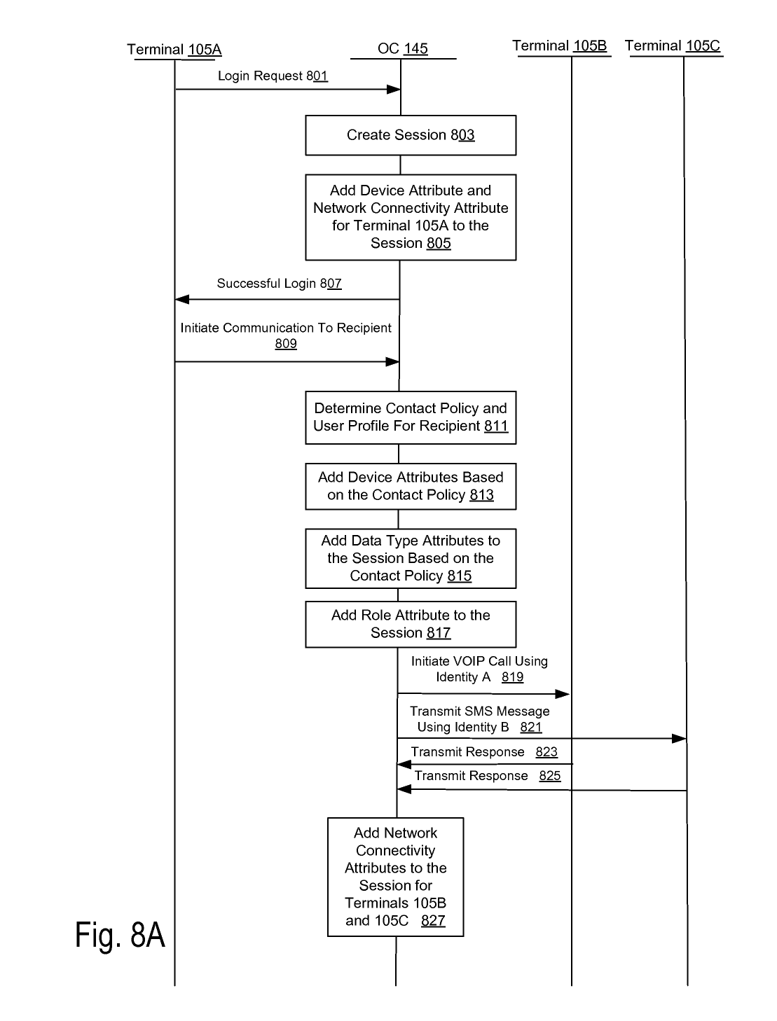

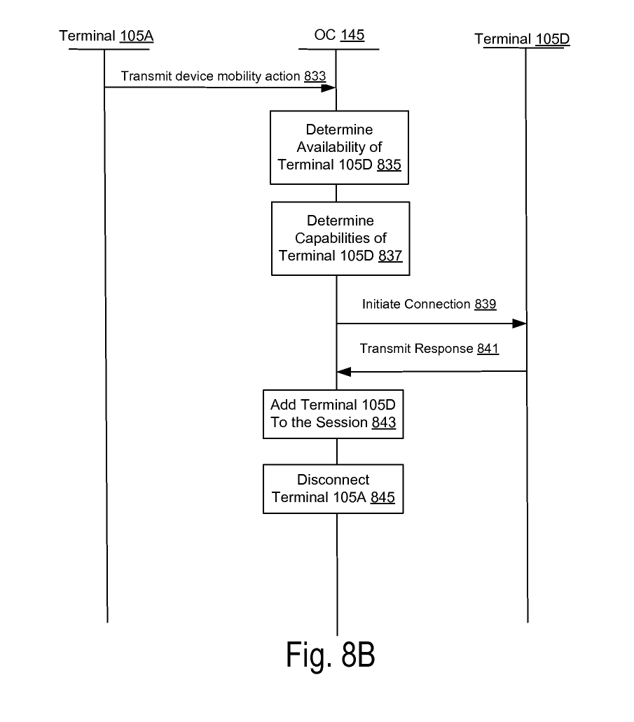

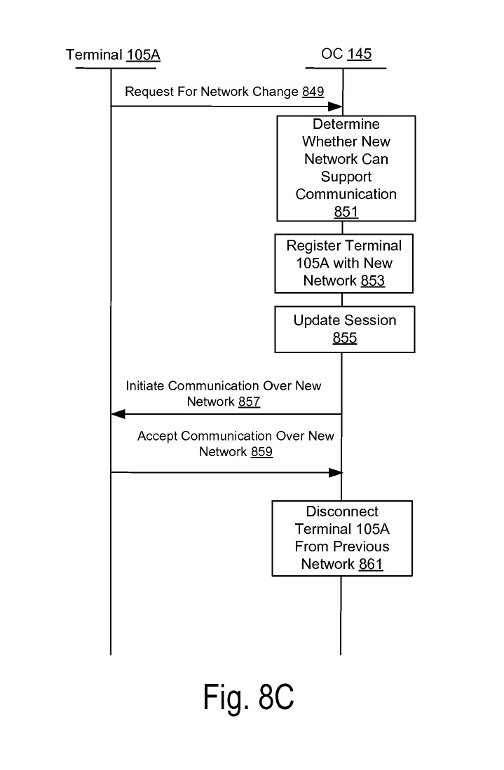

Referring now to FIG. 8A, there is shown an interaction diagram illustrating the interaction between OC server 145 and terminal devices 105A, 105B, and 105D responsive to the client 105A attempting to communicate with a recipient associated with terminal devices 105B and 105C according to one embodiment. In the embodiment shown in FIG. 8A, the OC server 145 functions as a proxy for communication between the terminal devices 105 in an established session. In other embodiments, different and/or additional steps other than those performed in FIG. 8A may be performed.

In one embodiment, the terminal device 105A transmits 801 a login request to the OC server 145. As mentioned previously, terminal device 105A comprises a user agent that allows terminal devices 105 to interface with the OC server 145. The terminal device 105A may transmit user login information entered into the user agent to the OC server 145. Responsive to receiving and authenticating the request, the OC server 145 creates 803 an empty session that will be used for facilitating communication between terminal device 105A and any requested recipients.

The OC server 145 configures the session by adding 805 to the session a device attribute and network connectivity attribute for client 105A. As described previously, the device attribute for client 105A describes the functional capabilities of terminal device 105A. In one embodiment, the OC server 145 may receive from terminal device 105A its capabilities. In other embodiments, the OC server 145 may receive from terminal device 105A a manufacturer model number or model name associated with client 105A. From the received information, the OC server 145 may determine from stored information the capabilities of client 105A. Once the capabilities of terminal device 105A are determined, the OC server 145 creates the device attribute for terminal device 105A that is added to the session.

To add the network connectivity attribute to the session, the OC server 145 determines local terminal devices of the user associated with terminal device 105A that are currently online and that are in the proximity to terminal device 105A. As mentioned previously, the user profile associated with the user of terminal device 105A includes a device status for each of the user's terminal devices. Based on the device status, the OC server 145 may determine which devices are available for communication and may communicate with the available devices to determine which devices are proximate to terminal device 105A. For each local terminal device in the vicinity of terminal device 105A, the OC server 145 creates a network connectivity attribute that is added to the session. Once the attributes for the terminal device 105A are added to the session, the OC server 145 transmits 807 to terminal device 105A an indication of a successful login.

The terminal device 105A may initiate 809 a communication to a recipient which is received by the OC server 145 such as “Call jdoe@Rambus.com.” As mentioned previously, the recipient may only expose a single identity to his or her contacts. Because only a single identity is exposed, the communication mechanism used to contact the recipient is decoupled from the identity. The initiation of the communication may be in the form of calling an email address or emailing a telephone number, for example.

The OC server 145 receives the initiation of the communication from the terminal device 105A and determines 811 the contact policy and user profile corresponding to the intended recipient of the communication request as stored in the policy information database 219 and the contact information database 217, respectively. In one embodiment, OC server 145 determines the intended recipient from the initiation of communication by terminal device 105A and then determines the intended recipient's contact policy based on the determined identity. For example, the identity (John Doe) of the intended recipient can be determined from the initiation request “Call jdoe@Rambus1.com” as the user associated with the email address jdoe@Rambus1.com.

Also, as mentioned previously, the contact policy describes the recipient's preferences for communication. Depending on the type of communication initiated (i.e., a call, email, or SMS message, etc.) or the identity of the initiator of the communication, the OC server 145 determines the communication mechanisms in which to contact the recipient as described by the recipient's contact policy. For example, if the type of communication that is initiated is a “call” as indicated in the request “Call jdoe@Rambus1.com” the OC server 145 determines whether to call the intended recipient's (John Doe) mobile phone, VOIP phone or work phone, for example, or may determine other forms of communication by which to contact the intended recipient as specified by the policy associated with the user John Doe.

In the example shown in FIG. 8A, the OC server 145 determines from the recipient's contact policy that the recipient prefers to be contacted via his or her VOIP phone and via SMS message on his or her mobile phone (i.e., the communication mechanisms). The OC server 145 determines the identities (i.e., phone numbers or usernames, etc.) of the recipient to contact via the determined communication mechanisms from the recipient's user profile. In this example, the OC server 145 determines the recipient's VOIP phone number or username (i.e., Identity A) and mobile phone number (i.e., Identity B) from the recipient's user profile. When the voice call is initiated to the recipient, the connection between the initiator (e.g., terminal device 105A) and the OC center 145 is initiated by the client of terminal device 105A placing the voice call to the OC server 145. The OC server 145 connects the call to the recipient according to the recipient's contact policy.

The OC server 145 updates the session to include the attributes of the terminal devices associated with the determined identities. The OC server 145 adds 813 device attributes for terminal devices 105B and 105C which are associated with the determined identities indicated by the contact policy. Additionally, the OC server adds 815 data type attributes to the session based on the contact policy. Because the contact policy of the recipient indicated that the recipient prefers to be contacted via a VOIP call and a SMS message to his or her mobile phone, the OC server creates for each of devices 105A, 105B, and 105C, a data type attribute for each media stream that is used during communication.

In this example, because a VOIP call and SMS message will be initiated, audio data type attributes are added to the session for terminals 105A and 105B for the audio portion of the VOIP call. Additionally, a messaging media type attribute is added to the session for the textual stream portion of the SMS message for client 105C if the audio portion of communication from device 105A is transcribed by the OC server 145 into a SMS message for client 105C.

In addition to contacting the terminal devices of the recipient, the OC server 145 updates the session to describe the roles of each terminal device in the communication. For each of terminal device 105A, 105B, and 105C, the OC server adds 817 a role attribute indicative of each terminal device's role to the session. In one embodiment, because terminal device 105A is the initiator of the communication, the OC server 145 may assign the role attribute of “session owner” to terminal device 105A whereas terminal device 105B and terminal device 105C are assigned the role attribute of “session guest.” As mentioned previously, the roles of each terminal device dictate the communication permissions in the session.

Because the recipient may be contacted on terminal devices that operate on different networks such as cellular network 115 and/or WLAN 130, the OC server 145 contacts terminal devices 105B and 105C through the network in which the device operates. In this example, the OC server 145 initiates 819 a VOIP call to terminal device 105B using Identity A on the WLAN 130. Additionally, the OC server 145 initiates 821 a SMS message to Identity B using cellular network 115.

As discussed previously, the user associated with terminal device 105A is exposed to the recipient of the communication according to the user's contact policy. Thus, the OC server 145 accesses the user's contact policy to determine how to present the user to the recipient of the communication. For example, the user's policy may only expose the user's email address to his or her contacts. Thus, the user's email address is presented on terminal device 105B responsive to terminal device 105B receiving the VOIP call. The OC server 145's facilitation of the communication between terminal devices 105 is transparent such that the user of terminal device 105A is not aware of the presence of OC server 145. To the user of terminal device 105A, it appears as if terminal device 105A contacted terminal devices 105B and 105C directly.

Responsive to receiving the communication, terminal device 105B transmits 823 a response (e.g., an acceptance of the communication) to the OC server 145. By accepting the communication, terminal 105A and 105B begin communicating with one another through the OC server 145. That is, the audio streams from both devices are communicated to one another through the OC server 145. Similarly, terminal device 105C transmits 825 a response (e.g., acknowledgement of receipt of the SMS message) to the OC server 145. The OC server 145 updates the session by adding 827 network connectivity attribute(s) for each local terminal device that is in proximity to terminal device 105B and terminal device 105C.

Referring now to FIG. 8B, there is shown an interaction diagram illustrating an embodiment of the interaction between OC server 145 and terminal devices 105A and 105D during device mobility. Note that other embodiments may perform different and/or additional steps other than those performed in FIG. 8B. Further note that the steps performed in FIG. 8B may be a continuation of those described by FIG. 8A or are performed when terminal device 105A is in communication with one or more other terminal devices.

In one embodiment, the terminal device 105A transmits 833 a device mobility action that is received by the OC server 145. The device mobility action is a request by the user of terminal device 105A to transfer the communication session from terminal device 105A to terminal device 105D which is also a device of the user initiating the request. In the context of the example illustrated in FIG. 8B, transferring the active communication from terminal device 105A to terminal device 105D results in terminal device 105D being in communication with terminal devices 105B and 105C.

Responsive to receiving the device mobility action, the OC server 145 determines 835 the availability of the terminal device 105D indicated in the request. The OC server 145 determines whether the terminal device 105D is available to the user based on the user profile of the user. Additionally, the OC server 105D determines whether terminal device 105D is already being used in another communication session. If terminal device 105D is unavailable, the OC server 145 may send an indication to terminal device 105A that the mobility action cannot be completed according to one embodiment.

Furthermore, OC server 145 determines 837 the capabilities of terminal device 105D to ensure that terminal device 105D is capable of rendering the current session. That is, the OC server 145 verifies that terminal device 105D is capable of handling the various data types of communication in the current session. In this example, the OC server 145 determines whether terminal device 105D is capable of rendering a VOIP call and SMS messages. Responsive to terminal device 105D being available and capable of rendering the session, the OC server 145 initiates 839 a connection with terminal device 105D. Responsive to receiving the request to communicate with the OC server 145, the terminal device 105D transmits 841 a response to the OC server 145 accepting the connection. In other embodiments, the OC server 145 may wait for a connection to be established in cases where a user agent is not installed on the terminal device (e.g., a traditional land line telephone).

Once the terminal device 105D is connected to the OC server 145, the OC server 145 adds 843 terminal device 105D to the session by updating the session with the attributes of terminal device 105D such as the device attribute, data type attribute(s) and network connectivity attribute(s) for client 105D. Additionally, the OC server 145 adds a role attribute for terminal device 105D. In this example, terminal device 105A is associated with the session owner attribute. Thus, the OC server 145 adds a session owner attribute for terminal device 105D to the session. Responsive to session being updated with the attributes for terminal device 105D, terminal device 105D is in communication with terminal devices 105B and 105C. The OC server 145 then disconnects 845 terminal device 105A from the conference. In one embodiment, the disconnection may occur immediately or after a period of time to ensure that the terminal device 105D is functioning properly. In different embodiments, the attributes for terminal device 105A may or may not be removed from the session.

In one embodiment, prior to transferring the communication session from terminal device 105A to terminal device 105D, the OC server 145 performs a security authentication for the request. The OC server 145 displays a key on terminal device 105D and requests that from the user confirmation of the key using the initiating terminal device 105A. The user inputs the key into terminal device 105A and transmits it to the OC server 145. Responsive to the key matching the key provided to terminal device 105D, the OC server 145 grants the request for session migration.

Referring now to FIG. 8C, there is shown an interaction diagram illustrating an embodiment of the interaction between OC server 145 and terminal devices 105A during network mobility. Note that other embodiments may perform different and/or additional steps other than those performed in FIG. 8C. Further note that the steps performed in FIG. 8C may be a continuation of those described by FIG. 8A or are performed when terminal device 105A is in communication with one or more other terminal devices and assumes that terminal device 105A is capable of communicating over different types of networks.

In one embodiment, terminal device 105A transmits a request 849 for a network change that is received by the OC server 145. For example, consider the scenario where the terminal device 105A is initially communicating with the OC server via cellular network 115 and may request to use WLAN 130 for communication with the OC server 145. The request may be prompted by the user of terminal device 105A in some embodiments. For example, the user of terminal device 105A may request to switch from using the cellular network 115 to the WLAN 130. In other embodiments, the request may be automatically made by the user agent on terminal device 105A after determining a better network connection is available for facilitating communication between terminal device 105A and terminal devices 105B and 105C.

Responsive to receiving the request, the OC server 145 determines 851 whether the new network associated with the request can support the current communication. That is, the OC server 145 and user agent of terminal device 105A perform a series of activities (e.g., latency, RSSI or QoS measurements) to determine if the new network path can support the migration of the session to the new network. The result of the determination may be stored by the OC server 145 for future use. By storing whether the network can support the migration, future requests to switch to the network may not require the determination whether the network path can support the migration of the session. Responsive to the OC server 145 determining that the new network can support the session migration, the OC server 145 registers 853 terminal device 105A with the new network by performing authentication processes so that the terminal device 105A may communicate over the new network. The OC server 145 then updates 855 the session to indicate the network change. For example, the device attribute may be updated to reflect that terminal device 105A is using the new network for communication with the OC server 145.

The OC server 145 initiates 857 communication with terminal device 105A over the new network. That is, the OC server 145 contacts the user agent of terminal device 105A over the new network. The communication between the user agent and the OC server 145 is seamless such that the user is not aware of the communication. The OC server 145 receives 859 an acceptance of the communication over the new network from terminal device 105A resulting in the terminal device 105A communicating with the OC server 145 over the new network. The OC server 145 disconnects 861 terminal device 105A from the previous network. Note that the terminal device 105A may access the cellular network 115 to establish an alternative connection.

### Client User Interfaces

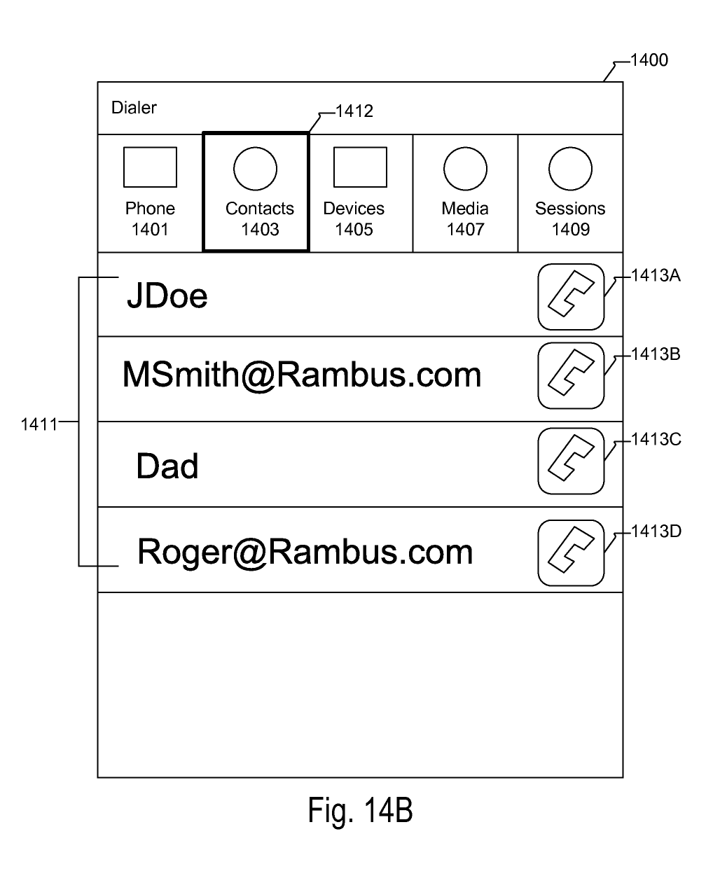

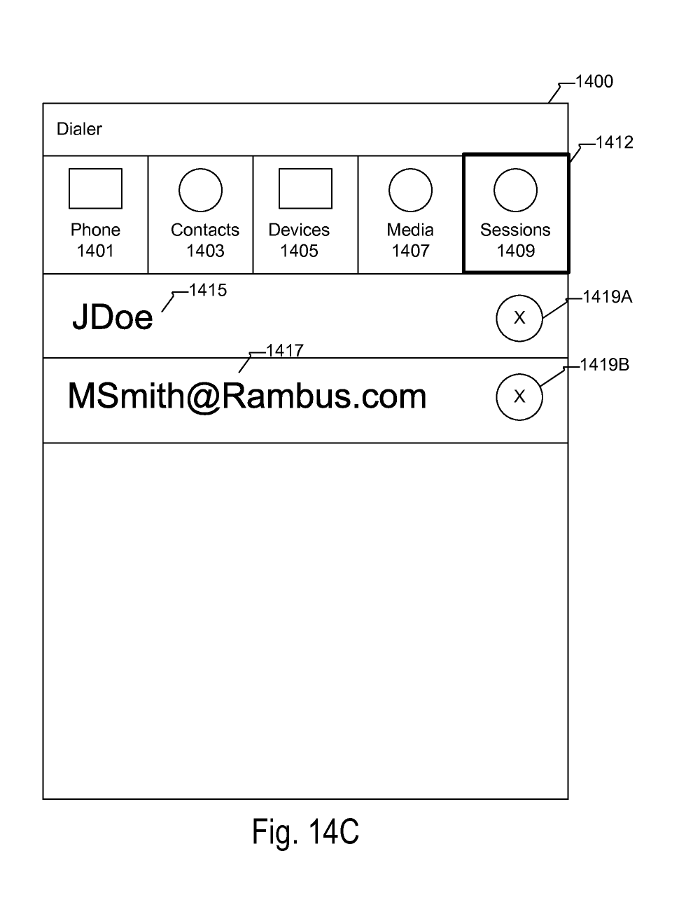

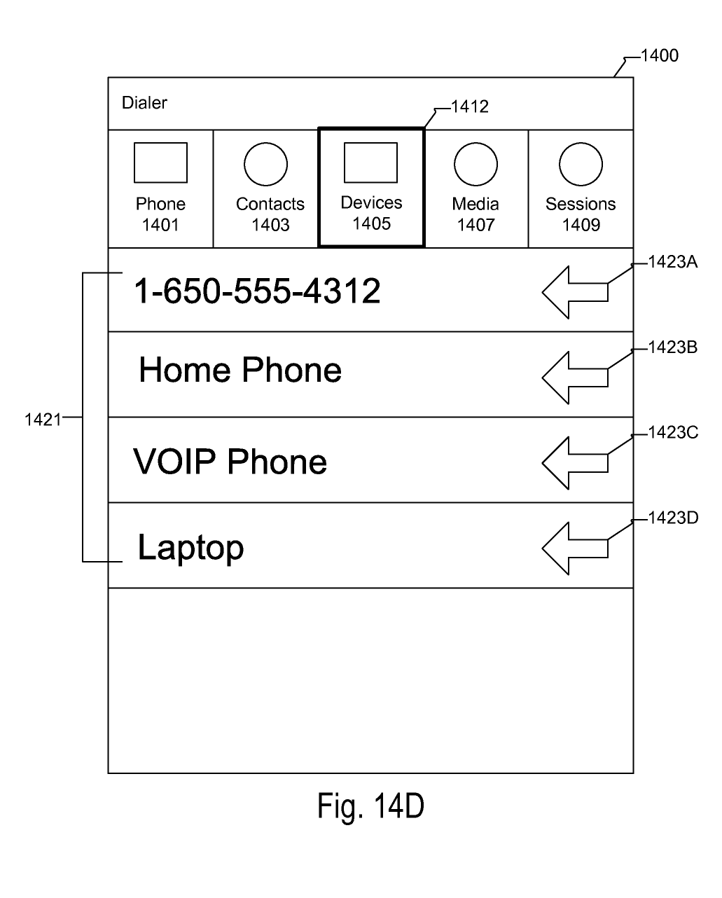

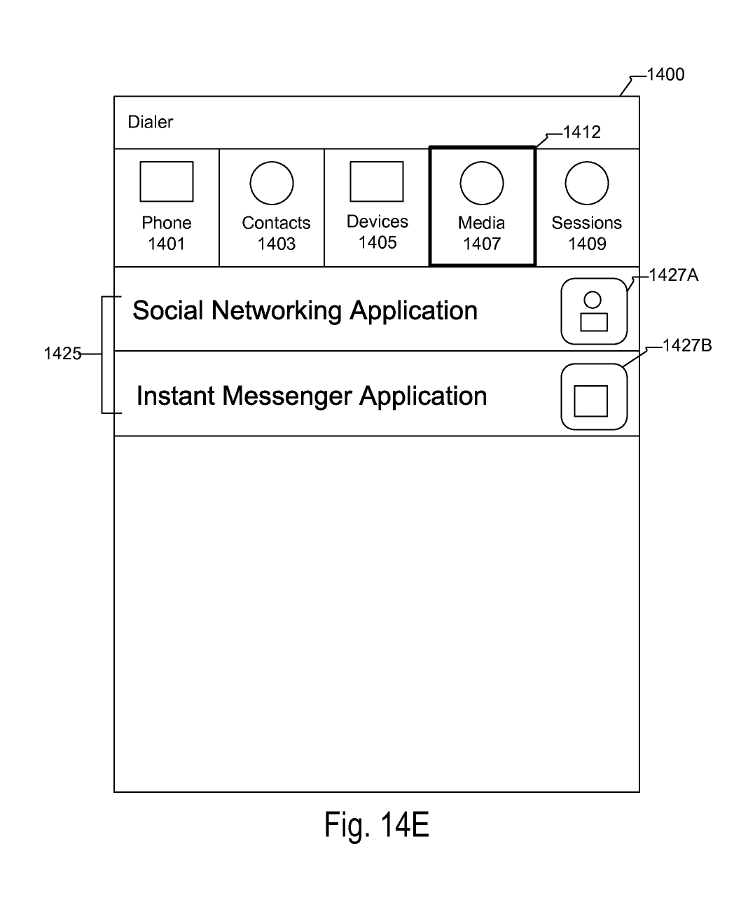

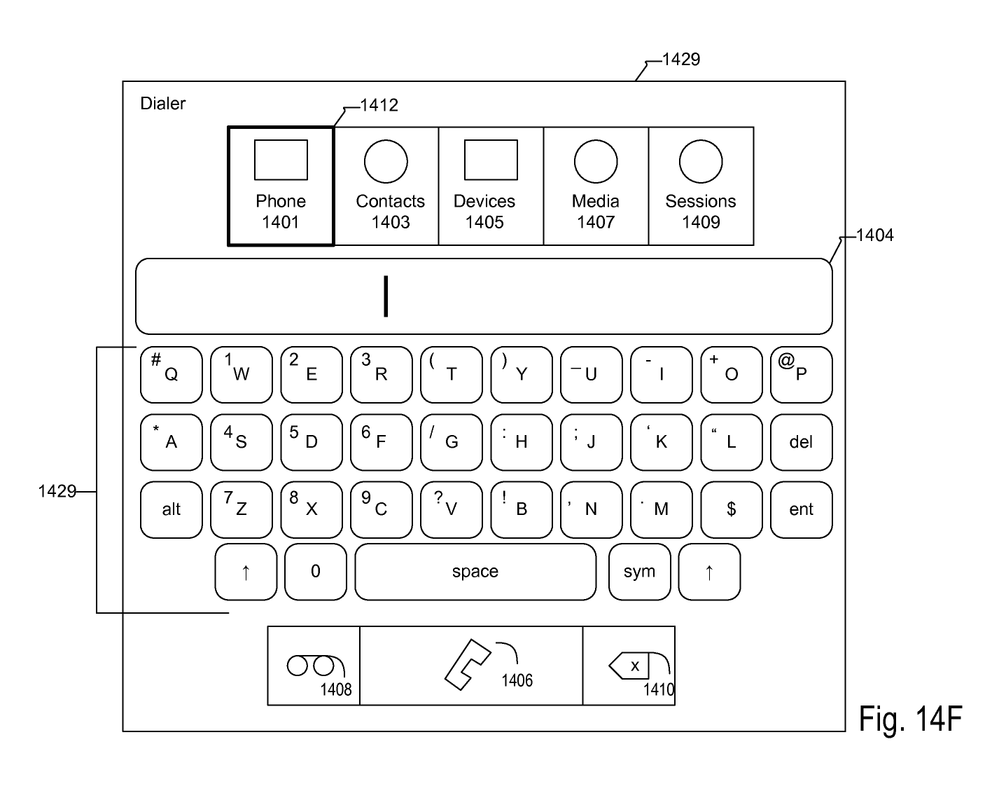

Referring to FIG. 14A, a user interface 1400 of the user agent included in a terminal device 105. The user interface 1400 comprises a plurality of menu options including a phone menu option 1401, a contacts menu option 1403, a devices menu option 1405, a media menu option 1407, and a session menu option 1409. The user of the terminal device 105 selects a menu of interest using cursor 1412. Responsive to selection of the menu, the user interface associated with the menu is illustrated to the user.

For example, selection of the phone menu option 1401 causes the user interface 1400 to display a phone menu. The phone menu comprises a keypad 1402. Any characters selected from the alphanumeric keypad 1402 are displayed in character field 1404. Additionally, the phone menu includes a dial element 1406 that causes the dialer to call any inputted number, a voice mail element 1408 to listen to received voice mails, and an end call element 1410 to end any active calls.

Responsive to the user selecting a contacts menu option 1403 using cursor 1412, the user interface 1400 displays the contacts menu as shown in FIG. 14B. The contacts menu displays the user's contact list 1411. As described previously, each contact in the contact list 1411 is displayed according to the contact's user policy. For example, the user associated with the username “JDoe” indicated in his her user profile to expose the identity “JDoe” rather than his or her name or contact information. Each of the other contacts included in contact list 1411 is also exposed per an associated user policy. Additionally, the contacts menu includes a communication initiation element (e.g., a button) 1413 that initiates communication with the contact via the OC server 145 as described above. For example, to contact JDoe, the user selects the contact communication element 1413A.

As mentioned above, the user interface 1400 also includes a sessions menu option 1409. Responsive to selection of the sessions menu option 1409 using the cursor 1412, the sessions menu is displayed as shown in FIG. 14C. The sessions menu displays the username (i.e., handle) of the people in an activate communication session with the user of the terminal device. For example, the user of the mobile phone may have an ongoing communication session with a person represented by the username “JDoe” 1415 and may also have another ongoing communication session with a second person represented by the username MSmith@Rambus.com 1417. To end an active communication session, the sessions menu provides user interface (UI) elements 1419, such as a button, that allow the user of the device to end an ongoing session. For example, UI element 1419A ends the session with JDoe 1415 whereas UI element 1419B ends the session with MSmith@Rambus.com 1417.

Responsive to selection of the devices menu option 1405 using cursor 1412, the user interface 1400 displays the devices menu as shown in FIG. 14D. The devices menu includes a device list 1421. The device list 1421 indicates the user's terminal devices that are nearby the user's current location or otherwise available to the user. Each device included in the list 1421 is available to the user for session migration. That is, the user may move an active communication session to one of the user's terminal devices in the nearby device list 1421 as described above.

The devices menu may also display devices known or otherwise assigned to the user such as the user's TV, the user's printer, or the user's projector. These devices may only be exposed to the user associated with the devices. Thus, other users in the communication session are not exposed to these devices. Additionally, the devices may not be in proximity or nearby the user at the time, such as when the user is texting and driving. By displaying devices that are not in proximity to the user, the user is made aware of his or her devices.

In one embodiment, each device in the nearby device list 1421 is presented according to the user's user profile. For example, the device associated with the number “1-650-555-4312” may be associated with the user's work phone and is presented according to the user's profile. To request session migration to a terminal device included in the list 1421, the user selects a session migration UI element 1423. Selection of the session migration UI element 1423 causes the user agent of the terminal device to send a request to the OC server 145 to migrate a selected session to the device associated with the request. For example, if the user wants to move a session to his or her VOIP phone, the user selects the session migration UI element 1423C.

Lastly, responsive to selection of the media menu option 1407 using cursor 1412, a media menu is displayed in user interface 1400 as shown in FIG. 14E. The media menu displays to the user a list of applications 1425 available to the user. To execute (i.e., open) an application, the user presses an application UI element 1427 associated with the application. For example, to execute the social networking application, the user selects the application UI element 1427A.

Referring now to FIG. 14F, an alternative user interface 1429 of the user agent included in a terminal device 105 is shown. The user interface 1429 includes similar features as those illustrated in user interface 1400 illustrated in FIG. 14A such as the phone menu option 1401, the contacts menu option 1403, the devices menu option 1405, the media menu option 1407, the session menu option 1409, and the cursor 1412 whose description is omitted for brevity. However, note that the keypad 1429 is a QWERTY keypad rather than the alphanumeric keypad 1402 illustrated in FIG. 14A. The QWERTY keypad 1429 allows a user to contact for example “Roger@Rambus.com.”

### Communication Path Generation

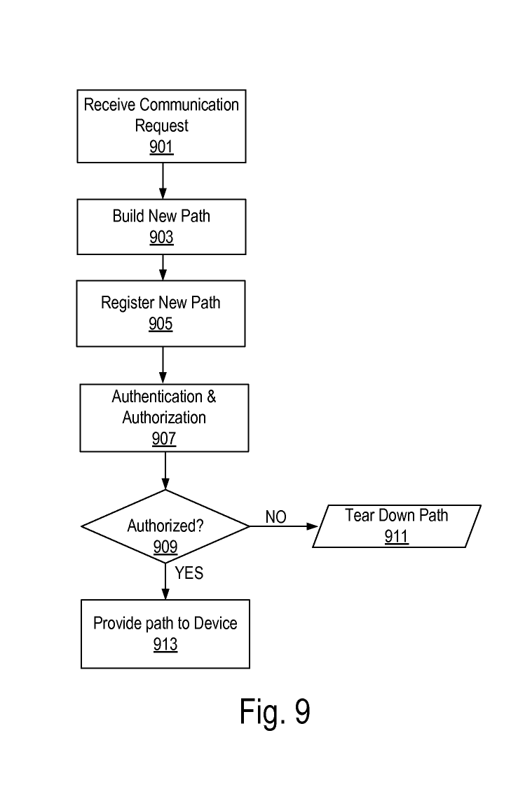

FIG. 9 illustrates a method in accordance with one embodiment of the present disclosure by which interworking network 140 establishes a communication path to at least one of terminal devices 105B and 105C through cellular network 115 and/or WLAN 130. For discussion purposes, the following description is with respect to building a communication path through the WLAN 130 to communicate with terminal device 105D but the following method may also be applied to establish a communication path through cellular network 115.

Note that in the following discussion, the interworking network 140 is assumed to have been authenticated by AAA 137 and AAA 125 and in communication with cellular network 115 and WLAN 130. In one embodiment, interworking network 140 has received a request from terminal device 105A over the cellular network 115 to place a VOIP call to terminal device 105D over WLAN 130. AAA 150 receives a communication request 901 from AAA 125 notifying interworking network 140 of the user's request to communicate with terminal device 105D. Interworking network 140 then communicates with terminal device 105D to build 903 a path between AAA 150 and terminal device 105D and registers 905 the new path. With the path established, AAA 150 communicates with terminal device 105A to authenticate 907 terminal device 105A and authorize the connection. The OC server 145 determines 909 if the connection by terminal device 105A is authorized. If the authentication is unsuccessful, then the OC server 145 tears 911 down the newly created path. If authorization is successful, OC server 145 establishes and maintains a path to terminal device 105D via WLAN 130. OC server 145 remains a network anchor point for the communication path between terminal device 105A and terminal device 105D until terminal device 105A or interworking network 115 releases the connection.

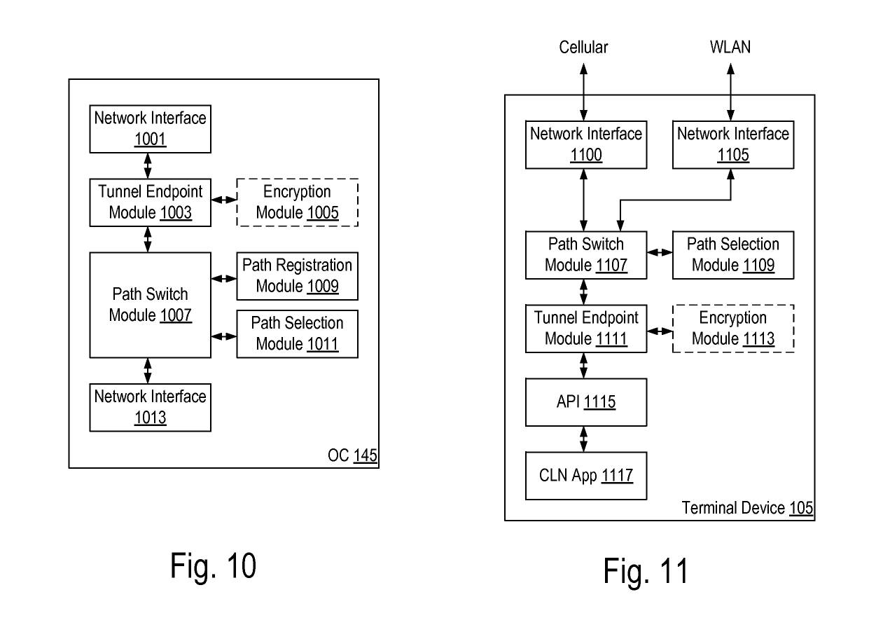

FIG. 10 is a block diagram of an embodiment of OC server 145 of FIG. 1. FIG. 10 illustrates the functional modules other than the communication manager 200 and contact database 203 shown in FIG. 2. OC server 145 includes a network interface 1001 to communicate with terminal device 105 via one or more defined communication paths. A tunnel endpoint module 1003 ensures the integrity of data passed between OC server 145 and terminal device 105. In a packet-switched network, tunnel endpoint module 1003 buffers and reorders packets, checks for errors, and requests retransmission as necessary. These actions are conventional, and the list of actions is not exhaustive. OC server 145 may additionally support encryption/decryption module 805 to provide secure connections.

A path switch module 1007 manages data flow for one or multiple paths defined between OC server 145 and terminal device 105. Path switch module 1007 is controlled by path registration module 1009 and path selection module 1011. Path registration module 1009 stores information used to define the communication path or paths. Path selection module 1011 includes information upon which OC server 145 bases decisions regarding path preferences. Path selection module 1011 may be programmed, for example, to achieve a desired minimum bandwidth or to achieve a maximum Internet bandwidth without exceeding a specified cost-per-byte. Whatever paths are specified, a second network interface 1013 manages communication with terminal devices. Note that in alternative embodiments, multiple types of networks may be utilized to provide improved compatibility rather than switching between different types networks.

FIG. 11 is a block diagram of terminal device 105, which includes a cellular network interface 1100 and a WLAN interface 1105. Cellular network interface 1100 can support any of the conventional cellular protocols, such as code-division multiple access (CDMA) or High Spend Packet Access (HSPA), or may be extended to other conventional or later adopted wireless protocols, such as whitespace radio. Network interface 1105 can likewise support conventional protocols, such as WiFi or WiMax, or may be extended to other protocols.

Terminal device 105 additionally includes a path switch module 1007 and path selection module 1109, which together select one or both interfaces 1100 and 1105 for communication. A tunnel endpoint module 1111 ensures data integrity in the manner of tunnel endpoint module 1003 and may likewise include encryption/decryption functionality provided by encryption module 1113. An application interface (API) 1115 provides a data interface between the tunnel endpoint module and a client application 1117 for communication with OC server 145.

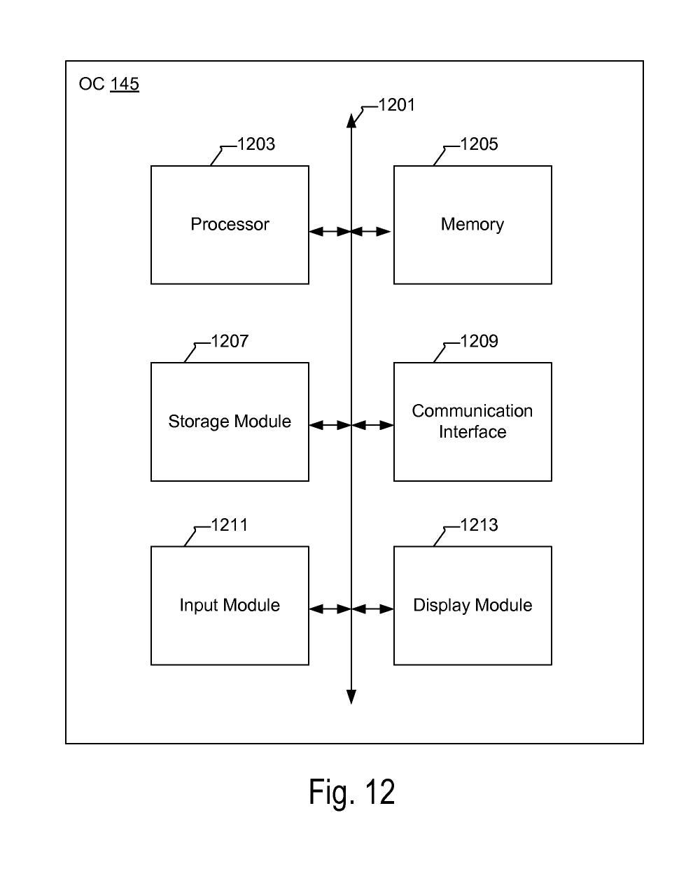

FIG. 12 illustrates the hardware architecture of OC server 145, according to one embodiment. In one embodiment, the OC server 145 is a server computer including components such as a processor 1203, a memory 1205, a storage module 1207, an input module (e.g., keyboard, mouse, and the like) 1211, a display module 1213, and a communication interface 1209, exchanging data and control signals with one another through a bus 1201. The storage module 1207 is implemented as one or more computer readable storage medium (e.g., hard disk drive), and stores software that is run by the processor 1203 in conjunction with the memory 1205 to implement the OC server functionality according to embodiments of the present disclosure as illustrated herein. Operating system software and other application software may also be stored in the storage device 1207 to run on the processor 1203. Note that not all components of the OC server 145 are shown in FIG. 12 and that certain components not necessary for illustration of the present invention are omitted herein.

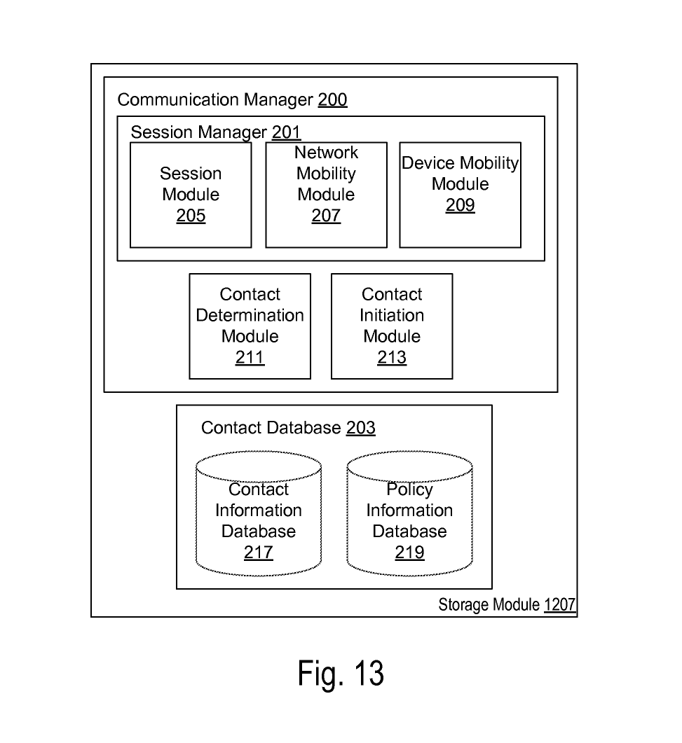

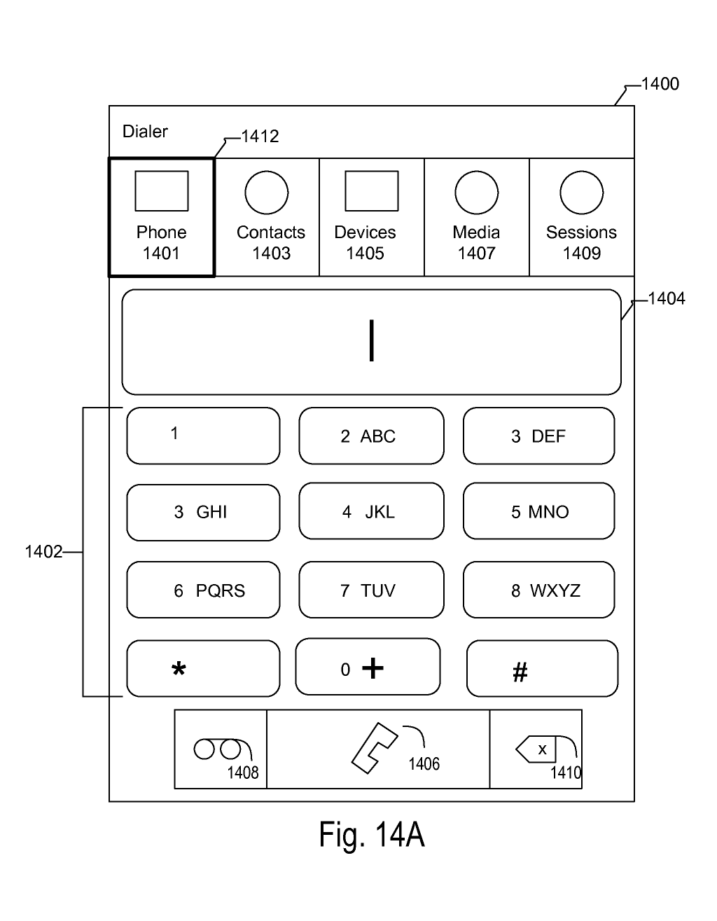

FIG. 13 illustrates the storage module 1207 of OC server 145 storing various software modules of the OC server 145, including a contact manager 200 comprising a session manager 201 and a contact database 203 comprising a contact information database 217 and a policy information database 219.

Upon reading this disclosure, those of ordinary skill in the art will appreciate still additional alternative structural and functional designs for managing sessions for facilitating communication between terminal devices over disparate networks, through the disclosed principles of the present disclosure. Thus, while particular embodiments and applications of the present disclosure have been illustrated and described, it is to be understood that the disclosure is not limited to the precise construction and components disclosed herein. Various modifications, changes and variations which will be apparent to those skilled in the art may be made in the arrangement, operation and details of the method and apparatus of the present disclosure disclosed herein without departing from the spirit and scope of the disclosure as defined in the appended claims.

1. At a server for facilitating communication between a first terminal device associated with a first user and a second terminal device associated with a second user, a computer-implemented method comprising:
establishing communication with the first terminal device via a first communication network;
creating a session including attributes of the first terminal device, the attributes of the first terminal device at least including a first device attribute indicative of functional capabilities of the first terminal device;
receiving from the first terminal device a request to establish communication with the second user;
updating the session to include (i) a data type attribute indicative of one or more data types for communication between the second terminal device and the server and (ii) attributes of the second terminal device, the attributes of the second terminal device including at least a second device attribute indicative of functional capabilities of the second terminal device; and
establishing communication between the server and the second terminal device to communicate data of the one or more data types via a second communication network.

2. The computer-implemented method of claim 1, further comprising:
updating the session to include a data type attribute indicative of one or more data types for communication between the first terminal device and the server.

3. The computer-implemented method of claim 1, further comprising:
updating the session to include a role attribute indicative of communication permissions associated with the first terminal device.

4. The computer-implemented method of claim 1, further comprising:
selecting the second terminal device from one or more available terminal devices associated with the second user for facilitating the communication.

5. The computer-implemented method of claim 1, further comprising:
determining one or more other available terminal devices associated with the first user that are located in proximity to the first terminal device; and
updating the session to include a network connectivity attribute indicating the one or more other available terminal devices that are located in proximity to the first terminal device.

6. The computer-implemented method of claim 5, further comprising:
receiving a request from one of the first terminal device and the second terminal device to move the communication with the server to a third terminal device;
updating the session to include attributes of the third terminal device, the attributes of the third terminal device including at least a third device attribute indicative of functional capabilities of the third terminal device and a data type attribute indicative of a data type communicated between the third terminal device and the server;
establishing communication between the server and the third terminal device; and
disconnecting the requesting terminal device from the communication with the server.

7. The computer-implemented method of claim 1, wherein the first communication network and the second communication network comprise different types of communication networks.

8. The computer-implemented method of claim 1, wherein the functional capabilities of the first terminal device comprise at least one of data types capable of being rendered, types of supported communication networks, and an indication of a communication network being used for communication with the server.

9. The computer-implemented method of claim 1, wherein the data types comprise at least one of audio data types, video data types, and messaging media types.

10. The computer-implemented method of claim 1, further comprising:
transferring the communication with the first terminal device to a third communication network selected from a plurality of available network connections that can support the one or more data types indicated by the data type attribute.

11. (canceled)

12. The computer-implemented method of claim 10, wherein transferring the communication comprises:
monitoring network performance of a plurality of network connections; and
automatically selecting the third communication network from the plurality of network connections based on the network performance of the third connection.

13. The computer-implemented method of claim 10, further comprising:
updating the session by updating the first device attribute to indicate the transfer of communication to the selected network connection.

14. (canceled)

15. (canceled)

16. (canceled)

17. The computer-implemented method of claim 2, further comprising:
receiving, from the first terminal device, data in the one or more data types for communication between the first terminal device and the server; and
formatting the received data for communication into another data type capable of being rendered by the second terminal device based on the second device attribute; and
communicating said formatted data to the second terminal device.

18. (canceled)

19. (canceled)

20. (canceled)

21. At a server for facilitating communication between a first terminal device of a first user and a second terminal device of a second user, a computer-implemented method for transferring communication from the first terminal device to a third terminal device of the first user, the method comprising:
receiving a request to transfer communication with the second terminal device from the first terminal device to the third terminal device;
adding attributes associated with the third terminal device to a previously created session including data for management of the communication, the attributes including a device attribute indicative of functional capabilities of the third terminal device;
establishing communication with the third terminal device; and
removing the first terminal device from the session.

22. The computer-implemented method of claim 21, wherein the data for management of the communication comprises a first device attribute indicative of functional capabilities of the first terminal device, a second device attribute indicative of functional capabilities of the second terminal device, and a data type attribute indicative of a data type communicated between the first terminal device and the server and between the second terminal device and the server.

23. The computer-implemented method of claim 21, further comprising:
removing a first device attribute indicative of functional capabilities of the first terminal device from the session upon removing the first terminal device from the session.

24. The computer-implemented method of claim 21, further comprising:
updating the session to include a role attribute indicative of communication permissions associated with the third terminal device.

25. The computer-implemented method of claim 24, wherein the communication permissions associated with the third terminal device indicate whether the third terminal device controls the session or is a guest in the session.

26. The computer-implemented method of claim 21, further comprising:
determining whether the third terminal device is capable of handling a data type that was incapable of being handled by the first terminal device; and
providing data in the data type to the third terminal device responsive to the determination indicating that the third terminal device is capable of handling the data type.

27. In a server for facilitating communication between a first terminal device in communication with a second terminal device through the server, a computer-implemented method for providing network mobility for the terminal devices during communication, the method comprising:
receiving a request from the first terminal device via a first type of communication network to transfer the communication with the server to a second type of communication network distinct from the first type of communication network;
updating a previously created session to include data for management of communication, the updated session comprising (i) a device attribute indicative of functional capabilities of the first terminal device and an indication of the transfer of communication to the second type of communication network, and (ii) a data type attribute indicative of one or more data types for communication between the first terminal device and the server and between a second terminal device and the server; and
transferring the communication of the first terminal device with the server to the second type of communication network.

28-49. (canceled)
